(19) United States
(12) Patent Application Publication
(10) Pub. No.: US 2026/0230117 A1
(43) Pub. Date: Aug. 6, 2026

(54) UPDATING COEFFICIENTS FOR RECONFIGURABLE SURFACE

(71) Applicant: QUALCOMM Incorporated, San Diego, CA (US)

(72) Inventors: Min HUANG, Beijing (CN); Chao WEI, Beijing (CN); Hao XU, Beijing (CN)

(21) Appl. No.: 19/155,169

(22) PCT Filed: Mar. 22, 2023
(86) PCT No.: PCT/CN2023/082974

§ 371 Date: Aug. 8, 2025

(51) Int. Cl. H04B 7/04

(52) U.S. Cl. CPC H04B 7/04013

(57) ABSTRACT

Methods, systems, and devices for wireless communications are described. A user equipment (UE) may receive, from a network entity, an indication of a first set of one or more values of configuration coefficients for a reconfigurable surface. The UE may receive, from the network entity, one or more reference signals via the reconfigurable surface while the reconfigurable surface is configured in accordance with the first set of one or more values of the configuration coefficients. The UE may determine, based on the first set of one or more values of the configuration coefficients and receiving the one or more reference signals, a second set of one or more values of the configuration coefficients for the reconfigurable surface. The UE may transmit, to the network entity, an indication of the second set of one or more values of the configuration coefficients for the reconfigurable surface.

### CROSS REFERENCE

The present application for patent is a 371 national phase filing of International Patent Application No. PCT/CN2023/082974 by HUANG et al., entitled “UPDATING COEFFICIENTS FOR RECONFIGURABLE SURFACE,” filed Mar. 22, 2023, assigned to the assignee hereof, and expressly incorporated by reference herein.

### FIELD OF TECHNOLOGY

The following relates to wireless communications, including updating coefficients for a reconfigurable surface.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some examples, a user equipment (UE) may communicate with a network entity. For instance, the UE may communicate with the network entity via a direct link between the UE and the network entity. In some examples, the direct link between the UE and the network entity may fail. For instance, an object may block the direct link. In such examples, the UE may fail to communicate with the network entity. Techniques that enable the UE to communicate with the network entity when the direct link is blocked may increase the efficiency of wireless communications.

### SUMMARY

The described techniques relate to improved methods, systems, devices, and apparatuses that support updating values of coefficients (e.g., reflection or refraction coefficients) for a reconfigurable surface. For example, the described techniques provide for a user equipment (UE) to use channel estimation to determine one or more values of one or more configuration coefficients (e.g., optimized coefficients, suggested coefficients) for a reconfigurable surface. For instance, the UE may receive, from a network entity, an indication of a first set of one or more values of configuration coefficients for a reconfigurable surface. The UE may receive, from the network entity, one or more reference signals via the reconfigurable surface while the reconfigurable surface is configured in accordance with the first set of one or more values of the configuration coefficients. The UE may determine, based on the first set of one or more values of the configuration coefficients and receiving the one or more reference signals, a second set of one or more values of the configuration coefficients (e.g., a set of one or more optimized or suggested values of the configuration coefficients) for the reconfigurable surface. The UE may transmit, to the network entity, an indication of the second set of one or more values of the configuration coefficients for the reconfigurable surface.

A method for wireless communication at a user equipment (UE) is described. The method may include receiving, from a network entity, an indication of a first set of one or more values of configuration coefficients for a reconfigurable surface, receiving, from the network entity, one or more reference signals via the reconfigurable surface while the reconfigurable surface is configured in accordance with the first set of one or more values of the configuration coefficients, determining, based on the first set of one or more values of the configuration coefficients and receiving the one or more reference signals, a second set of one or more values of the configuration coefficients for the reconfigurable surface, and transmitting, to the network entity, an indication of the second set of one or more values of the configuration coefficients for the reconfigurable surface.

An apparatus for wireless communication is described. The apparatus may include a memory, a transceiver, and at least one processor of a UE, the at least one processor coupled with the memory and the transceiver. The at least one processor may be configured to receive, from a network entity, an indication of a first set of one or more values of configuration coefficients for a reconfigurable surface, receive, from the network entity, one or more reference signals via the reconfigurable surface while the reconfigurable surface is configured in accordance with the first set of one or more values of the configuration coefficients, determine, based on the first set of one or more values of the configuration coefficients and receiving the one or more reference signals, a second set of one or more values of the configuration coefficients for the reconfigurable surface, and transmit, to the network entity, an indication of the second set of one or more values of the configuration coefficients for the reconfigurable surface.

Another apparatus for wireless communication at a UE is described. The apparatus may include means for receiving, from a network entity, an indication of a first set of one or more values of configuration coefficients for a reconfigurable surface, means for receiving, from the network entity, one or more reference signals via the reconfigurable surface while the reconfigurable surface is configured in accordance with the first set of one or more values of the configuration coefficients, means for determining, based on the first set of one or more values of the configuration coefficients and receiving the one or more reference signals, a second set of one or more values of the configuration coefficients for the reconfigurable surface, and means for transmitting, to the network entity, an indication of the second set of one or more values of the configuration coefficients for the reconfigurable surface.

A non-transitory computer-readable medium storing code for wireless communication at a UE is described. The code may include instructions executable by a processor to receive, from a network entity, an indication of a first set of one or more values of configuration coefficients for a reconfigurable surface, receive, from the network entity, one or more reference signals via the reconfigurable surface while the reconfigurable surface is configured in accordance with the first set of one or more values of the configuration coefficients, determine, based on the first set of one or more values of the configuration coefficients and receiving the one or more reference signals, a second set of one or more values of the configuration coefficients for the reconfigurable surface, and transmit, to the network entity, an indication of the second set of one or more values of the configuration coefficients for the reconfigurable surface.

Some examples of the method, apparatuses, and non-transitory computer-readable medium described herein may further include operations, features, means, or instructions for receiving, from the network entity, an indication of one or more parameters for a communications link between the network entity and the reconfigurable surface, where the one or more parameters include a propagation delay, a propagation direction, a transmission power, or any combination thereof, and where transmitting the indication of the second set of one or more values of the configuration coefficients may be based on receiving the indication of the one or more parameters.

In some examples of the method, apparatuses, and non-transitory computer-readable medium described herein, the indication of the first set of one or more values of configuration coefficients includes an indication of a first pattern for activation or deactivation of each of a set of elements of the reconfigurable surface and the indication of the second set of one or more values of the configuration coefficients includes an indication of a second pattern for activation or deactivation of each of the set of elements of the reconfigurable surface.

In some examples of the method, apparatuses, and non-transitory computer-readable medium described herein, the indication of the first set of one or more values of configuration coefficients includes an indication of a first set of weight vectors and the indication of a second set of one or more values of configuration coefficients includes an indication of a second set of weight vectors.

In some examples of the method, apparatuses, and non-transitory computer-readable medium described herein, the indication of the first set of weight vectors includes an indication of a first set of codewords indices and the indication of the second set of weight vectors includes an indication of a second set of codeword indices.

In some examples of the method, apparatuses, and non-transitory computer-readable medium described herein, the indication of the first set of weight vectors includes an indication of a respective phase and a respective amplitude for each element of each weight vector of the first set of weight vectors and the indication of the second set of weight vectors includes an indication of a respective phase and a respective amplitude for each element of each weight vector of the second set of weight vectors.

In some examples of the method, apparatuses, and non-transitory computer-readable medium described herein, the indication of the second set of one or more values of the configuration coefficients indicates a codeword from a codebook.

Some examples of the method, apparatuses, and non-transitory computer-readable medium described herein may further include operations, features, means, or instructions for transmitting, to the network entity, an indication of whether the codeword may be from a first type of codebook or a second type of codebook.

In some examples of the method, apparatuses, and non-transitory computer-readable medium described herein, the second set of one or more values of the configuration coefficients corresponds to a weighted sum of a set of multiple codewords and the indication of the second set of one or more values of the configuration coefficients indicates the set of multiple codewords and a set of weights for obtaining the weighted sum of the set of multiple codewords.

In some examples of the method, apparatuses, and non-transitory computer-readable medium described herein, the second set of one or more values of the configuration coefficients may be provided via a message from the UE and the message includes an indication of a quantity of sub-surfaces included in the reconfigurable surface.

In some examples of the method, apparatuses, and non-transitory computer-readable medium described herein, the message further includes an indication of whether the sub-surfaces included in the reconfigurable surface may be equal or unequal in size.

In some examples of the method, apparatuses, and non-transitory computer-readable medium described herein, the second set of one or more values of the configuration coefficients for the reconfigurable surface includes a respective set of one or more values of configuration coefficients for each sub-surface of a set of multiple sub-surfaces included in the reconfigurable surface.

In some examples of the method, apparatuses, and non-transitory computer-readable medium described herein, the indication of the second set of one or more values of the configuration coefficients indicates a respective one or more codebooks, respective combination coefficients for the one or more codebooks, or both, for each sub-surface of the set of multiple sub-surfaces included in the reconfigurable surface.

In some examples of the method, apparatuses, and non-transitory computer-readable medium described herein, the indication of the second set of one or more values of the configuration coefficients indicates a respective phase and a respective amplitude for each value of the second set of one or more values of the configuration coefficients for each sub-surface of the set of multiple sub-surfaces included in the reconfigurable surface.

A method for wireless communication at a network entity is described. The method may include outputting an indication of a first set of one or more values of configuration coefficients for a reconfigurable surface, outputting one or more reference signals via the reconfigurable surface while the reconfigurable surface is configured in accordance with the first set of one or more values of the configuration coefficients, and obtaining an indication of a second set of one or more values of the configuration coefficients for the reconfigurable surface based on transmitting the indication of the first set of one or more values of the configuration coefficients and transmitting the one or more reference signals.

An apparatus for wireless communication is described. The apparatus may include a memory and at least one processor of a network entity, the at least one processor coupled with the memory. The at least one processor may be configured to to output an indication of a first set of one or more values of configuration coefficients for a reconfigurable surface, output one or more reference signals via the reconfigurable surface while the reconfigurable surface is configured in accordance with the first set of one or more values of the configuration coefficients, and obtain an indication of a second set of one or more values of the configuration coefficients for the reconfigurable surface based on transmitting the indication of the first set of one or more values of the configuration coefficients and transmitting the one or more reference signals.

Another apparatus for wireless communication at a network entity is described. The apparatus may include means for outputting an indication of a first set of one or more values of configuration coefficients for a reconfigurable surface, means for outputting one or more reference signals via the reconfigurable surface while the reconfigurable surface is configured in accordance with the first set of one or more values of the configuration coefficients, and means for obtaining an indication of a second set of one or more values of the configuration coefficients for the reconfigurable surface based on transmitting the indication of the first set of one or more values of the configuration coefficients and transmitting the one or more reference signals.

A non-transitory computer-readable medium storing code for wireless communication at a network entity is described. The code may include instructions executable by a processor to output an indication of a first set of one or more values of configuration coefficients for a reconfigurable surface, output one or more reference signals via the reconfigurable surface while the reconfigurable surface is configured in accordance with the first set of one or more values of the configuration coefficients, and obtain an indication of a second set of one or more values of the configuration coefficients for the reconfigurable surface based on transmitting the indication of the first set of one or more values of the configuration coefficients and transmitting the one or more reference signals.

Some examples of the method, apparatuses, and non-transitory computer-readable medium described herein may further include operations, features, means, or instructions for outputting an indication of one or more parameters for a communications link between the network entity and the reconfigurable surface, where the one or more parameters include a propagation delay, a propagation direction, a transmission power, or any combination thereof, and where receiving the indication of the second set of one or more values of the configuration coefficients may be based on transmitting the indication of the one or more parameters.

In some examples of the method, apparatuses, and non-transitory computer-readable medium described herein, the indication of the first set of one or more values of configuration coefficients includes an indication of a first pattern for activation or deactivation of each of a set of elements of the reconfigurable surface and the indication of the second set of one or more values of the configuration coefficients includes an indication of a second pattern for activation or deactivation of each of the set of elements of the reconfigurable surface.

In some examples of the method, apparatuses, and non-transitory computer-readable medium described herein, the indication of the first set of one or more values of configuration coefficients includes an indication of a first set of weight vectors and the indication of a second set of one or more values of configuration coefficients includes an indication of a second set of weight vectors.

In some examples of the method, apparatuses, and non-transitory computer-readable medium described herein, the indication of the first set of weight vectors includes an indication of a first set of codewords indices and the indication of the second set of weight vectors includes an indication of a second set of codeword indices.

In some examples of the method, apparatuses, and non-transitory computer-readable medium described herein, the indication of the first set of weight vectors includes an indication of a respective phase and a respective amplitude for each element of each weight vector of the first set of weight vectors and the indication of the second set of weight vectors includes an indication of a respective phase and a respective amplitude for each element of each weight vector of the second set of weight vectors.

In some examples of the method, apparatuses, and non-transitory computer-readable medium described herein, the indication of the second set of one or more values of the configuration coefficients indicates a codeword from a codebook.

Some examples of the method, apparatuses, and non-transitory computer-readable medium described herein may further include operations, features, means, or instructions for outputting an indication of whether the codeword may be from a first type of codebook or a second type of codebook.

In some examples of the method, apparatuses, and non-transitory computer-readable medium described herein, the second set of one or more values of the configuration coefficients corresponds to a weighted sum of a set of multiple codewords and the indication of the second set of one or more values of the configuration coefficients indicates the set of multiple codewords and a set of weights for obtaining the weighted sum of the set of multiple codewords.

In some examples of the method, apparatuses, and non-transitory computer-readable medium described herein, the second set of one or more values of the configuration coefficients may be provided via a message and the message includes an indication of a quantity of sub-surfaces included in the reconfigurable surface.

In some examples of the method, apparatuses, and non-transitory computer-readable medium described herein, the message further includes an indication of whether the sub-surfaces included in the reconfigurable surface may be equal or unequal in size.

In some examples of the method, apparatuses, and non-transitory computer-readable medium described herein, the second set of one or more values of the configuration coefficients for the reconfigurable surface includes a respective set of one or more values of configuration coefficients for each sub-surface of a set of multiple sub-surfaces included in the reconfigurable surface.

In some examples of the method, apparatuses, and non-transitory computer-readable medium described herein, the indication of the second set of one or more values of the configuration coefficients indicates a respective one or more codebooks, respective combination coefficients for the one or more codebooks, or both, for each sub-surface of the set of multiple sub-surfaces included in the reconfigurable surface.

In some examples of the method, apparatuses, and non-transitory computer-readable medium described herein, the indication of the second set of one or more values of the configuration coefficients indicates a respective phase and a respective amplitude for each value of the second set of one or more values of the configuration coefficients for each sub-surface of the set of multiple sub-surfaces included in the reconfigurable surface.

### BRIEF DESCRIPTION OF THE DRAWINGS

FIG. 1 shows an example of a wireless communications system that supports updating coefficients for a reconfigurable surface in accordance with one or more aspects of the present disclosure.

FIG. 2 shows an example of a wireless communications system that supports updating coefficients for a reconfigurable surface in accordance with one or more aspects of the present disclosure.

FIG. 3 shows an example of a wireless communications system that supports updating coefficients for a reconfigurable surface in accordance with one or more aspects of the present disclosure.

FIG. 4 shows an example of a process flow that supports updating coefficients for a reconfigurable surface in accordance with one or more aspects of the present disclosure.

FIGS. 5 and 6 show block diagrams of devices that support updating coefficients for a reconfigurable surface in accordance with one or more aspects of the present disclosure.

FIG. 7 shows a block diagram of a communications manager that supports updating coefficients for a reconfigurable surface in accordance with one or more aspects of the present disclosure.

FIG. 8 shows a diagram of a system including a device that supports updating coefficients for a reconfigurable surface in accordance with one or more aspects of the present disclosure.

FIGS. 9 and 10 show block diagrams of devices that support updating coefficients for a reconfigurable surface in accordance with one or more aspects of the present disclosure.

FIG. 11 shows a block diagram of a communications manager that supports updating coefficients for a reconfigurable surface in accordance with one or more aspects of the present disclosure.

FIG. 12 shows a diagram of a system including a device that supports updating coefficients for a reconfigurable surface in accordance with one or more aspects of the present disclosure.

FIGS. 13 and 14 show flowcharts illustrating methods that support updating coefficients for a reconfigurable surface in accordance with one or more aspects of the present disclosure.

### DETAILED DESCRIPTION

A user equipment (UE) may communicate with a network entity. For instance, the UE may communicate with the network entity via a direct link between the UE and the network entity. In order to enable the UE to better receive transmissions from the network entity, the UE may perform channel estimation for the direct link prior to receiving the transmissions. In some examples, the UE and network entity may communicate over a reflective link provided by a reconfigurable surface (e.g., a reconfigurable intelligent surface (RIS)) that is configured to reflect transmissions received from the UE and the network entity. In some such examples, the reconfigurable surface may be configured in accordance with one or more values of one or more configuration coefficients (e.g., one or more reflection or refraction coefficients) in order to orient transmissions towards the UE from the network entity. In order to estimate the configuration coefficient, the UE may perform channel estimation and may provide one or more values for the one or more configuration coefficients to the network entity. However, if the UE performs channel estimation for receiving transmissions from the network entity and for configuring the one or more configuration coefficients at the same time, the resulting channel estimation may be inaccurate for receiving transmissions that follow after, as the reconfigurable surface may adjust how it orients transmissions towards the UE based on the indicated configuration coefficient.

The techniques described herein may enable a UE to indicate to the network (e.g., as part of a channel state information (CSI) report) a suggested (e.g., optimized) set of one or more values for one or more configuration coefficients for a reconfigurable surface, to support improvement communications by the UE using the reconfigurable surface to reflect or refract signals. In some examples, the UE may be able to determine one or more values for one or more configuration coefficients for the reconfigurable surface prior to performing channel estimation for receiving control and/or data transmissions from the network entity via the reconfigurable surface.

For instance, the UE may receive an indication of a first set of values of the configuration coefficients from the network entity (e.g., via the direct link). The UE may also receive one or more reference signals via the reconfigurable surface, where the reconfigurable surface may be configured in accordance with the first set of values when the reference signals are transmitted. The UE may use the first set of values of the configuration coefficients and reference signals received from the network entity to determine a second set of values of the configuration coefficients. The UE may transmit an indication of the second set of values of the configuration coefficients to the network entity and/or directly to the reconfigurable surface. In examples in which the UE transmits the indication of the second set of values to the network entity, the network entity may transmit another indication of the second set of values to the reconfigurable surface. After the reconfigurable surface receives the second set of values of the configuration coefficient, the UE may perform channel estimation for receiving a control transmission and/or data transmission from the network entity. During channel estimation, the reconfigurable surface may use the second set of values of the configuration coefficients in order to direct reference signals to the UE.

Aspects of the disclosure are initially described in the context of wireless communications systems. Additional aspects of the disclosure are described in the context of a process flow. Aspects of the disclosure are further illustrated by and described with reference to apparatus diagrams, system diagrams, and flowcharts that relate to updating coefficients for a reconfigurable surface.

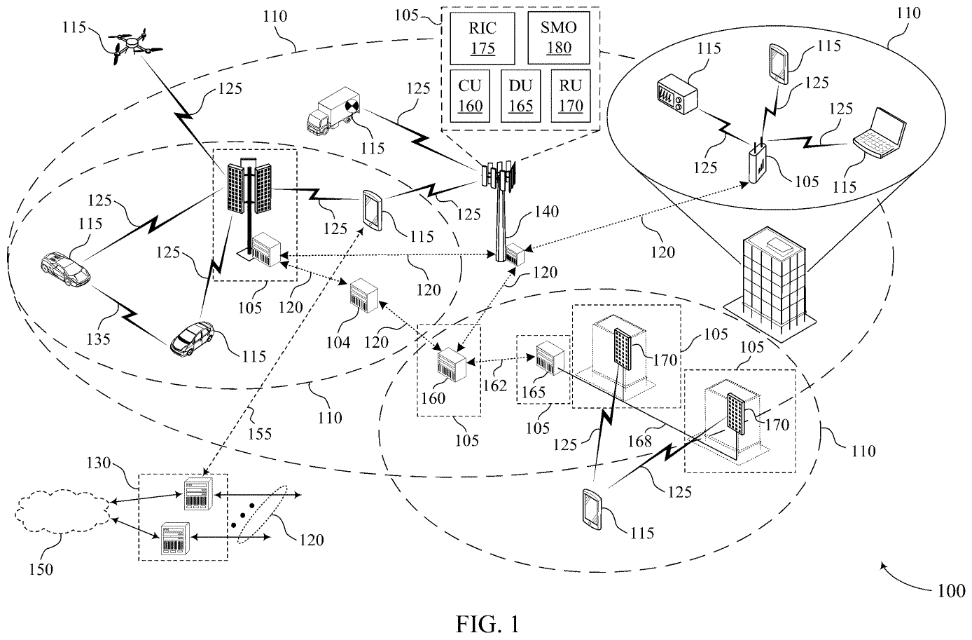

FIG. 1 shows an example of a wireless communications system 100 that supports updating coefficients for a reconfigurable surface in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, anode of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support updating coefficients for a reconfigurable surface as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may communicate with a network entity 105. For instance, the UE 115 may communicate with the network entity 105 via a direct link between the UE 115 and the network entity 105. In order to enable the UE 115 to better receive transmissions from the network entity 105, the UE 115 may perform channel estimation for the direct link prior to receiving the transmissions. In some examples, the UE 115 and network entity 105 may communicate over a reflective link provided by a reconfigurable surface (e.g., a reconfigurable intelligent surface) that is configured to reflect transmissions received from the UE 115 and the network entity 105. In some such examples, the reconfigurable surface may be configured in accordance with one or more configuration coefficients (e.g., one or more reflection or refraction coefficients) in order to orient transmissions towards the UE 115 from the network entity 105. In order to estimate the configuration coefficient, the UE 115 may perform channel estimation and may provide a value for the one or more configuration coefficients to the network entity 105. However, if the UE 115 performs channel estimation for receiving transmissions from the network entity 105 and for configuring the one or more configuration coefficients at the same time, the resulting channel estimation may be inaccurate for receiving transmissions that follow after, as the reconfigurable surface may adjust how it orients transmissions towards the UE 115 based on the indicated configuration coefficient.

The techniques described herein may enable the UE 115 to determine the one or more configuration coefficients prior to performing channel estimation for receiving control and/or data transmissions from the network entity 105. For instance, the UE 115 may receive an indication of a first set of values of the one or more configuration coefficients from the network entity 105 (e.g., via the direct link), where the first set of values of the one or more configuration coefficients may be the configured set of values of the one or more configuration coefficients at the reconfigurable surface when the indication of the first set of values of the one or more configuration coefficients is transmitted. The UE 115 may use the first set of values of the one or more configuration coefficients and reference signals received from the network entity 105 (e.g., via the reflective link and/or the direct link) to determine a second set of values of the one or more configuration coefficients. The UE 115 may transmit an indication of the second set of values of the one or more configuration coefficients to the network entity 105 and/or directly to the reconfigurable surface. In examples in which the UE 115 transmits the indication of the second set of values to the network entity 105, the network entity 105 may transmit another indication of the second set of values to the reconfigurable surface. After the reconfigurable surface receives the second set of values of the configuration coefficient, the UE 115 may perform channel estimation for receiving a control transmission and/or data transmission from the network entity 105. During channel estimation, the reconfigurable surface may use the second set of values of the one or more configuration coefficients in order to direct reference signals to the UE 115.

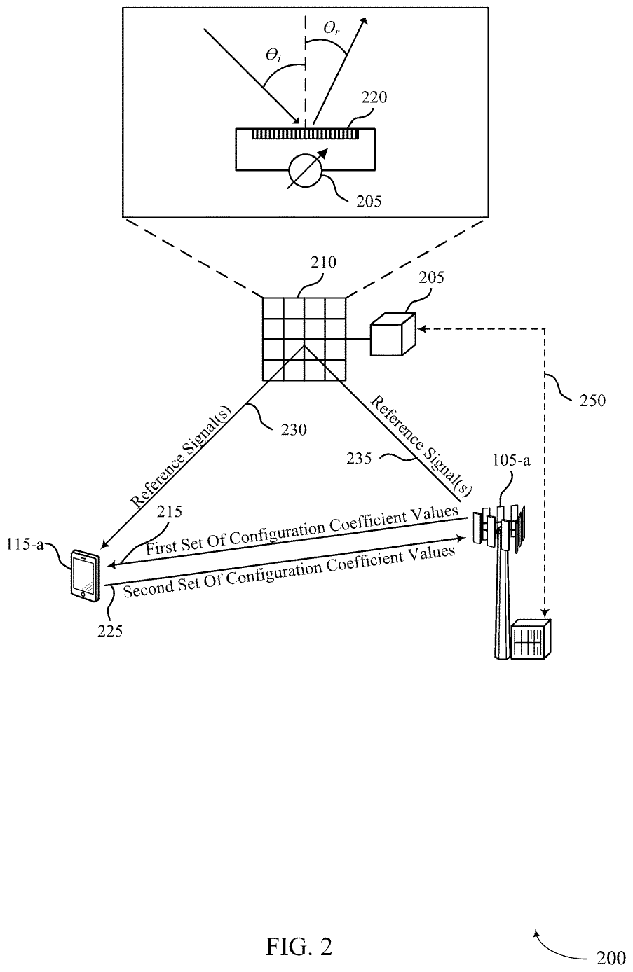

FIG. 2 shows an example of a wireless communications system 200 that supports updating coefficients for a reconfigurable surface in accordance with one or more aspects of the present disclosure. The wireless communications system 200 may implement or be implemented by aspects of the wireless communications system 100. For example, the wireless communications system 200 may include a network entity 105-a and a UE 115-a, which may be examples of corresponding devices described with reference to FIG. 1. In the wireless communications system 200, the UE 115-a may communicate with the network entity 105-a via a RIS 210.

In some examples, the RIS 210 may be controlled by the network entity 105-a. For example, the network entity 105-a may control the RIS 210 over an interface 250. In other examples, the RIS 210 may be controlled by a central RIS controller. The RIS 210 may be used to relay (e.g., deflect, refract, reflect) signals between the network entity 105-a and the UE 115-a. For example, a wave (e.g., an incident wave) may arrive at the RIS 210 with an incident angle (e.g., θᵢ), and may exit the RIS 210 (e.g., as a reflected wave) with a reflected angle (e.g., θᵣ). In some examples, the RIS 210 may be an example of a surface with a quantity of densely placed reconfigurable meta-elements that may reflect or refract an electromagnetic wave in a target direction.

The RIS 210 may be configured with a controller 205 that can adjust or otherwise configure directional settings of the RIS 210. For example, the controller 205 may adjust gratings 220 on the RIS 210 to control the angle at which waves are reflected off the RIS 210. By adjusting the gratings 220 of the RIS 210, the controller 205 may be capable of steering waves (e.g., signals) in a specific direction. In some examples, the controller 205 may provide a low amount of power to the surface of the RIS 210 to improve the reflective properties of the RIS 210 (e.g., to increase the power or quality of signals reflected by the RIS 210). The amount of power consumed by the RIS 210 may be negligible in comparison to power amplifiers or other active relay devices.

In some examples, a reflective link may exist between UE 115-a and network entity 105-a via the RIS 210. In some such examples, a direct link (e.g., a direct communication link). between UE 115-a and network entity 105-a may not be established and/or maintained. For instance, the direct link may be blocked by an object (e.g., a building, a tree). In other example, the direct link and the reflective link may be established and/or maintained (e.g., cases in which the direct link is not block by an object). In some examples, network entity 105-a and/or UE 115-a may estimate a channel for a portion of the reflective link between the RIS 210 and the network entity 105-a as channel estimation coefficient H_{gr}. Additionally, network entity 105-a and/or UE 115-a may estimate a channel for a portion of the reflective link between the RIS 210 and UE 115-a as channel estimation coefficient Hᵣᵤ. Additionally or alternatively, network entity 105-a and/or UE 115-a may estimate a channel for the direct link between UE 115-a and network entity 105-a as channel estimation coefficient H_{gu}. Additionally, network entity 105-a and/or UE 115-a may generate a reflection coefficient vector wᵣ for the RIS 210 and may determine a precoding weight matrix W_{g} for network entity 105-a to use in transmitting downlink data transmissions. It should be noted that the techniques described herein may be performed regardless of whether downlink-uplink reciprocity is assumed.

When network entity 105-a transmits a signal from a transmit antenna m and UE 115-a receives the signal only over the reflective link, the received signal at UE 115-a from antenna m may be determined as yₘ=Hᵣᵤ*Diag(wᵣ)*H_{gr}(:, m)x+noise=Hᵣᵤ*Diag (H_{gr}(:, m))*wᵣx+noise, where Diag may represented a diagonal matrix generated for the given input, and x may represent a signal transmitted by network entity 105-a. If Aₘ≙HᵣᵤDiag (H_{gr}(:, m))∈ [symbol] ^{N}^{ᵤ}^{×N}^{ᵣ}, then yₘ=Aₘwᵣx+noise. When network entity 105-a transmits a precoded signal from each transmit antenna, the received signal at UE 115-a may be given as y=Hᵣᵤ*Diag(wᵣ)*H_{gr}W_{g}x+noise=Hᵣᵤ*Diag(wᵣ)*Diag(wᵣ)[H_{gr}(:,1), H_{gr}(:,2), . . . , H_{gr}(:, N_{g})]*W_{g}x+noise=Hᵣᵤ*[Diag(H_{gr}(:,1)), Diag(H_{gr}(:,2)), . . . , Diag(H_{gr}(:, N_{g}))]*(I_{N}_{_{g}}⊗wᵣ)*W_{g}x+noise=[A₁, A₂, . . . , A_{N}_{_{g}}](I_{N}_{_{g}}⊗wᵣ)*W_{g}x+noise.

Alternatively, when network entity 105-a transmit a signal from a transmit antenna m and UE 115-a receives the signal over the reflective link and the direct link, the received signal at UE 115-a from antenna m may be determined as

$${y}_{m} = ( {H}_{gu} ( : , m ) + {H}_{ru} * Diag ( {w}_{r} ) * {H}_{gr} ( : , m ) ) x + noise = [ {H}_{gu} ( : , m ) , {H}_{ru} * Diag ( {H}_{gr} ( : , m ) ) ] * [ \begin{matrix}1 \\ {w}_{r}\end{matrix} ] x + noise . If {\tilde{A}}_{m} {=}^{Δ} [ {H}_{gu} ( : , m ) , {H}_{ru} * Diag ( {H}_{gr} ( : , m ) ) ] ∈ {ℂ}^{{N}_{u} \times ( {N}_{r} + 1 )} , and {\tilde{w}}_{r} = [ \begin{matrix}1 \\ {w}_{r}\end{matrix} ] , then {y}_{m} = {\tilde{A}}_{m} {\tilde{w}}_{r} x + noise .$$

When network entity 105-a transmits a precoded signal from each transmit antenna, the received signal at UE 115-a may be given as y=(H_{gu}+Hᵣᵤ*Diag(wᵣ)*H_{gr})*W_{g}x+noise=[Ã₁, Ã₂, . . . , Ã_{N}_{_{g}}](I_{N}_{_{g}}⊗\tilde{w}ᵣ)*W_{g}x+noise.

In some examples, multiple measurements with different RIS coefficients (e.g., reflection or refraction coefficients) may be performed. For instance, when a transmit antenna m of network entity 105-a transmits a signal, T measurements may be made with different w_{r,t} (e.g., y_{m,t}=Aₘw_{r,t}xₜ+noise, t=1~T). In some such examples, B≙[w_{r,1}, w_{r,2}, . . . , w_{r,T}]∈ [symbol] ^{N}^{ᵣ}^{×T} and for the transmit antenna m, the aggregated measured channel

$${H}_{m}^{meas} = [ \frac{{y}_{m , 1}}{{x}_{1}} , \frac{{y}_{m , 2}}{{x}_{2}} , ... , \frac{{y}_{m , T}}{{x}_{T}} ] = {A}_{m} [ {w}_{r , 1} , {w}_{r , 2} , ... , {w}_{r , T} ] + noise = {A}_{m} B + noise .$$

In some examples, network entity 105-a and/or UE 115-a may perform one or more methods for channel estimation. In a first example, a per-element on-off may be performed. For instance, each element of the RIS may be switched on or off individually. Accordingly, when the RIS is configured to switch on each element, w_{r,t}=[0, . . . , 0, 1, 0, . . . , 0]^{T} and the corresponding column of Aₘ may be derived. In a second example, based on a least square (LS) criterion, Aₘ may be estimated as Āₘ=YᵢB^{H}(BB^{H})⁻¹. In such examples, to enable matrix inversion, rank (B)=N, where K≥Nᵣ. In some example, the least criterion may be applied when Nᵣ has a small value (e.g., a value below a predefined threshold value). In a third example, channel estimation may be performed based on compressive sensing (CS). For instance, a sparse channel model may be assumed in which a radio channel has sparse paths. In such examples, the channel may be modeled such that

$${H}_{gr} ( : , m ) = {\sum }_{l = 1}^{L} {β}_{l} {α}_{l} ( {θ}_{l}^{ri} , {φ}_{l}^{ri} ) and {H}_{ru} = {\sum }_{k = 1}^{K} {γ}_{k} {α}_{k} ( {θ}_{k}^{u} , {φ}_{k}^{u} ) {a}_{k}^{H} ( {θ}_{k}^{ro} , {φ}_{k}^{ro} ) ,$$

where

$${α}_{l} ( {θ}_{l}^{ri} , {φ}_{l}^{ri} )$$

may be a steering vector with incident direction

$$( {θ}_{l}^{ri} , {φ}_{l}^{ri} )$$

### at the RIS 210,

$${α}_{k} ( {θ}_{k}^{u} , {φ}_{k}^{u} )$$

may be a steering vector with receiving direction

$$( {θ}_{k}^{u} , {φ}_{k}^{u} )$$

### at UE 115-a, and

$${α}_{k}^{H} ( {θ}_{k}^{ro} , {φ}_{k}^{ro} )$$

may be a steering vector with reflective direction

$${α}_{k} ( {θ}_{k}^{ro} , {φ}_{k}^{ro} )$$

at the RIS 210. In such examples, for a transmit antenna

$$m , {A}_{m} = {H}_{ru} * Diag ( {H}_{gr} ( : , m ) ) = {\sum }_{k = 1}^{K} {\sum }_{l = 1}^{L} {γ}_{k} {β}_{l} {α}_{k} ( {θ}_{k}^{u} , {φ}_{k}^{u} ) {b}_{k , l}^{H} ( {θ}_{k}^{ro} , {φ}_{k}^{ro} , {θ}_{l}^{ri} , {φ}_{l}^{ri} ) ,$$

$$where$$

$${b}_{k , l}^{H} ( {θ}_{k}^{ro} , {φ}_{k}^{ro} , {θ}_{l}^{ri} , {φ}_{l}^{ri} ) = {α}_{k} ( {θ}_{k}^{u} , {φ}_{k}^{u} ) ⊙ {α}_{l} ( {θ}_{l}^{ri} , {φ}_{l}^{ri} ) ,$$

where ⊙ means element-wise product. In some such examples, there may be KL virtual paths, each of which may corresponds to a path pair (k, l)≙j. Accordingly,

$${\sum }_{j = 1}^{KL} {p}_{j} {a}_{k ( j )} ( {θ}_{k ( j )}^{u} , {φ}_{k ( j )}^{u} ) {b}_{k ( j ) , l ( j )}^{u} ( {θ}_{k ( j )}^{ro} , {φ}_{k ( j )}^{ro} , {θ}_{l ( j )}^{ri} , {φ}_{l ( j )}^{ri} ) ,$$

$$where$$

$${p}_{j} = {γ}_{k ( j )} {β}_{l ( j )} .$$

In order to ensure convergency, multiple measurements with different w_{r,t} may be made with different T=1~T. In some examples, CS may be employed if a small number of variables is used (e.g., below a threshold quantity of variables). In some examples, the RIS incident direction

$$( {θ}_{l}^{ri} , {φ}_{l}^{ri} )$$

in the portion of the reflective link between network entity 105-a and RIS 210 may be determined during pre-measurement. Accordingly, in some such examples,

$${A}_{m} = {\sum }_{j = 1}^{KL} {p}_{j} {a}_{k ( j )} ( {θ}_{k ( j )}^{u} , {φ}_{k ( j )}^{u} ) {b}_{k ( j ) , l ( j )}^{u} ( {θ}_{k ( j )}^{ro} , {φ}_{k ( j )}^{ro} \vert {θ}_{l ( j )}^{ri} , {φ}_{l ( j )}^{ri} ) .$$

Additionally or alternatively, in some examples, network entity 105-a, UE 115-a, and RIS 210 may all be located in a horizontal plane and a one-dimensional direction may be considered. In such examples,

$${A}_{m} = {\sum }_{j = 1}^{KL} {p}_{j} {a}_{k ( j )} ( {θ}_{k ( j )}^{u} ) {b}_{k ( j ) , l ( j )}^{u} ( {θ}_{k ( j )}^{ro} \vert {θ}_{l ( j )}^{ri} ) .$$

In some examples, performing the per-element on-off for channel estimation may be associated with a reduced processing cost as compared to other techniques and may be robust to fit multiple types of topologies and conditions. Additionally or alternatively, performing the LS for channel estimation may be robust to fit to multiple types of topologies and conditions and may have an increased receiver signal strength as compared to other techniques. Additionally or alternatively, performing the CS for channel estimation may be associated with reduced radio resource consumption as compared to other techniques and the quantity of measurements performed may be smaller than a total quantity of RIS elements. In some examples, CS may be performed in examples in which the number of RIS elements is increased and LS and/or per-element on-off may be performed in examples in which the number of RIS elements is reduced. In some examples, LS may be performed when a signal received from a single RIS element would have insufficient power for channel estimation and/or per-element on-off may be performed when the signal would have sufficient power for channel estimation.

The present disclosure describes techniques for a network entity 105-a, UE 115-a, and RIS 210 to employ protocols and signaling to estimate RIS channels (e.g., the reflective link channels). Additionally, the present disclosure describes techniques for channel estimation of a reflective link channel and a direct link channel.

For instance, network entity 105-a may transmit a first set of configuration coefficient values 215 to UE 115-a (e.g., over the direct link). As described herein, UE 115-a may use B≙[w_{r,1}, w_{r,2}, . . . , w_{r,T}] in order to perform channel estimation (e.g., when network entity 105-a is transmitting one or more reference signals 235). For channel estimation with per-element on/off, w_{r,t}=[0, . . . , 0, 1, 0, . . . , 0]^{T}, t=1~T. Accordingly, for the per-element on/off method,

$${\{ {w}_{r , t} \}}_{t = 1}^{T}$$

may be used as a RIS per-element on/off pattern. For LS-based and CS-based channel estimation as described herein,

$${\{ {w}_{r , t} \}}_{t = 1}^{T}$$

may include different vectors. As described herein, when network entity 105-a transmits the first set of configuration coefficient values 215, network entity 105-a may indicate the information of the RIS reflective coefficient vectors B that are associated with RIS-related reference signals (e.g., CSI-RS) to one or both of RIS 210 and/or UE 115-a. For instance, network entity 105-a may configure a set of RIS-related reference signal resources or ports, each of which corresponds to one RIS reflective coefficient vector.

As described herein, in some examples, the information of the RIS reflective coefficient vectors (e.g., the first set of configuration coefficient values 215) may be a RIS per-element on/off pattern which indicates an order of switching on/off each RIS element in turn. In some cases, a group of elements of RIS 210 may share a same control and, in such cases, the information may indicate an order of switching on or off each RIS element group in turns. For instance, the RIS per-element on/off pattern may be a row first pattern (e.g., where each column is gone through for a row before proceeding to the next row, and where this is performed for each row) or a column first pattern (e.g., where each row is gone through for a column before proceeding to the next column, and where this is performed for each column). In other examples, the information of the RIS reflective coefficient vectors may be an indicator of a set of RIS reflective weight vectors. In some such examples, the codebook for RIS reflective weight vectors (e.g., a discrete Fourier transform (DFT) matrix) may be configured via signaling (e.g., from network entity 105-a) or pre-configured. For instance, the message including the first set of configuration coefficient values 215 may include a set of indices of codewords out of a codebook. Additionally or alternatively, the message including the first set of configuration coefficient values 215 may include an indication of a phase and/or amplitude of each element in each RIS reflective weight vector. Whether the information is a RIS per-element on/off pattern or a set of RIS reflective weight vectors may be configured by network entity 105-a. In some such examples, the first set of configuration coefficient values 215 may be in an RRC signaling message (e.g., a CSI report configuration RRC signaling message), a MAC CE message, or downlink control information (DCI).

In some examples (e.g., if the RIS 210 is deployed statically), channel estimation for the portion of the reflective link between network entity 105-a and UE 115-a may be performed before transmitting the first set of configuration coefficient values 215. In such examples, network entity 105-a may indicate this information to UE 115-a (e.g., via the direct link) to assist UE 115-a in channel estimation. The indicated information may include a delay, direction angles (an azimuth angle of departure, an azimuth angle of arrival, a zenith angle of arrival, a zenith angle of departure, a power of a set of radio signal propagation paths in the portion of the reflective link between network entity 105-a and RIS 210, or any combination thereof. In some examples, this information may be conveyed in an RRC signaling message (e.g., a CSI report configuration RRC signaling message), a MAC CE message, or DCI. In some examples, network entity 105-a may refrain from transmitting this information to UE 115-a before transmitting the first set of configuration coefficient values 215 (e.g., in examples in which the RIS 210 is not deployed statically).

After transmitting the first set of configuration coefficient values 215, network entity 105-a may transmit one or more reference signals 235 to RIS 210 (e.g., via the reflective link). RIS 210 may reflect the one or more reference signals 235 as one or more reference signals 230 and may provide the one or more reference signals 230 to UE 115-a. In some examples, the RIS 210 may reflect the reference signals of each resource and/or port with the associated reflective coefficient vector.

After UE 115-a receives the one or more reference signals 230, UE 115-a may transmit a second set of configuration coefficient values 225 to network entity 105-a. For instance, after receiving the RIS-related reference signals, UE 115-a may perform channel estimation based on receiving information of the RIS reflective coefficient vectors (e.g., the first set of configuration coefficients values 215) and the reference signals (e.g., one or more reference signals 230).

After receiving the first set of configuration coefficient values 215 and/or the channel information associated with the portion of the reflective link between network entity 105-a and RIS 210, UE 115-a may estimate a channel matrix

$${\{ {A}_{m} \}}_{m = 1}^{{N}_{g}}$$

for the RIS reflective link or

$${\{ {\tilde{A}}_{m} \}}_{m = 1}^{{N}_{g}}$$

for both the RIS reflective link and the direct link. After determining the channel matrix, UE 115-a may determine a RIS reflective coefficient vector wᵣ (e.g., an optimal RIS reflective coefficient vector) and/or a corresponding network entity precoding matrix W_{g}. In some examples (e.g., examples in which channel estimation is performed accounting just for the reflective link),

$${w}_{r}^{opt}$$

may be derived as

$${w}_{r}^{opt} = {arg}_{{w}_{r}}^{max} {\sum }_{m = 1}^{{N}_{g}} {‖ {A}_{m} {w}_{r} ‖}^{2} . If {\sum }_{m = 1}^{{N}_{g}} {‖ {A}_{m} {w}_{r} ‖}^{2} = {‖ {Aw}_{r} ‖}^{2} ,$$

where A≙[A₁; A₂; . . . ; A_{N}_{_{g}}], then

$${w}_{r}^{opt}$$

may be a major singular vector of A. In some examples (e.g., examples in which channel estimation is performed accounting for the reflective link and the direct link),

$${w}_{r}^{opt} = {arg}_{{w}_{r}}^{max} {\sum }_{m = 1}^{{N}_{g}} {‖ {\tilde{A}}_{m} {w}_{r} ‖}^{2} . If {‖ {\tilde{A}}_{m} {w}_{r} ‖}^{2} = {‖ \tilde{A} {w}_{r} ‖}^{2}$$

$$where$$

$$\tilde{A} {=}^{Δ} [ {\tilde{A}}_{1} ; {\tilde{A}}_{2} ; … ; {\tilde{A}}_{{N}_{g}} ] , then [ \begin{matrix}1 \\ {w}_{r}^{opt}\end{matrix} ]$$

may be a major singular vector of Ã. When there are multiple sub-bands, A or Ã may be an average value through each of the sub-bands. In some examples, UE 115-a may quantize and report

$${w}_{r}^{opt}$$

based on a configured or pre-configured RIS reflective coefficient codebook.

In a first such example, UE 115-a may report

$$- {w}_{r}^{opt}$$

(e.g., updated RIS reflective coefficients) using a Type-1 codebook. The Type-1 codebook for the RIS may have a size of

$${N}_{1}^{RIS} \times {N}_{2}^{RIS} : {𝕊}_{1} = {\{ {c}_{n} \}}_{n = 1 }^{{N}_{c}} ,$$

where each cₙ is a candidate codeword and N_{c} is a total number of codewords in the codebook. UE 115-a may select and report a codeword from codebook [symbol] ₁ that has a maximum covariance coefficient with

$${w}_{r}^{opt} .$$

In some examples, the codebook construction may use the RIS incident angles

$$( {θ}_{l}^{r i} , {φ}_{l}^{r i} )$$

and reflective angles

$$( {θ}_{l}^{ro} , {φ}_{l}^{ro} )$$

as the codeword indices (e.g., based on a sine function). For example,

$${c}_{n} = {w}_{r} ( {l}_{1} , {l}_{2} , {l}_{3} , {l}_{4} ) = [ 1 , exp ( - \frac{2 π d}{λ} ( sin {θ}_{{l}_{1}}^{r i} + s i n {θ}_{{l}_{2}}^{r o} ) ) , … , exp ( - \frac{2 π d ( {N}_{2}^{RIS} - 1 )}{λ} ( sin {θ}_{{l}_{1}}^{r i} + sin {θ}_{{l}_{2}}^{ro} ) ) ] ⊗ [ 1 , exp ( - \frac{2 π d}{λ} ( s i n {θ}_{{l}_{3}}^{r i} + s i n {θ}_{{l}_{4}}^{r o} ) ) , … , exp ( - \frac{2 π d ( {N}_{2}^{RIS} - 1 )}{λ} ( sin {θ}_{{l}_{3}}^{r i} + s i n {θ}_{{l}_{4}}^{r o} ) ) ] ,$$

where ⊗ means Kronecker product. In such examples, l₁, l₂, l₃, and l₄ may each be derived from n. Because

$$- \frac{π}{2} < {θ}_{l}^{r i} , {φ}_{l}^{r i} , {θ}_{l}^{r o} , {φ}_{l}^{r o} < \frac{π}{2} , {θ}_{l}^{r i} = \frac{π l}{{N}_{1}^{CB}} - \frac{π}{2} , l = 0 ∼ {N}_{1}^{C B} - 1 ; {θ}_{l}^{r o} = \frac{π l}{{N}_{2}^{CB}} - \frac{π}{2} , l = 0 ∼ {N}_{2}^{CB} - 1 ; {φ}_{l}^{r i} = \frac{π l}{{N}_{3}^{CB}} - \frac{π}{2} , l = 0 ∼ {N}_{3}^{CB} - 1 ; and {φ}_{l}^{r o} = \frac{π l}{{N}_{4}^{CB}} - \frac{π}{2} , l = 0 ∼ {N}_{4}^{CB} - 1.$$

In some examples, each of

$${N}_{1}^{CB} , {N}_{2}^{CB} , {N}_{3}^{CB} , and {N}_{4}^{CB}$$

may be configured by network entity 105-a. In other examples, the codebook construction (e.g., based on a DFT matrix) may use the sum of two sine function values as codeword indices. For example,

$${w}_{r} ( {l}_{1} , {l}_{2} ) = [ 1 , exp ( - \frac{2 π d}{λ} {x}_{{l}_{1}} ) , … , exp ( - \frac{2 π d ( {N}_{2}^{RIS} - 1 )}{λ} {x}_{{l}_{1}} ) ] ⊗ [ 1 , exp ( - \frac{2 π d}{λ} {y}_{{l}_{2}} ) , … , exp ( - \frac{2 π d ( {N}_{2}^{RIS} - 1 )}{λ} {y}_{{l}_{2}} ) ] .$$

In such examples, l₁ and l₂ may be derived from n. Because

$$- 2 < x , y < 2 , {x}_{{l}_{1}} = \frac{4 l}{{N}_{1}^{CB}} - 2 , l = 0 ∼ {N}_{1}^{C B} - 1 and {y}_{{l}_{2}} = \frac{4 l}{{N}_{2}^{CB}} - 2 , l = 0 ∼ {N}_{2}^{CB} - 1.$$

In some examples, each of

$${N}_{1}^{CB} and {N}_{2}^{CB}$$

may be configured by network entity 105-a. The codewords described herein may be for a 3D radio channel, where θ or x may represent a horizontal angle while φ or y may represent a vertical angle. For a 2-D radio channel, the φ-related or y-related entries may be removed.

In a second such example, UE 115-a may report

$${w}_{r}^{opt}$$

(e.g., updated RIS reflective coefficients) using a Type-2 codebook. For instance, UE 115-a may determine that no codeword in Type-1 codebooks has sufficient accuracy and/or precision to report

$${w}_{r}^{opt}$$

and may thus use Type 2-codebooks. The Type-2 codebooks may be constructed as a weighted sum of multiple codewords from a Type-1 codebook

$$( e . g . , {\sum }_{i = 0}^{L - 1} {α}_{i} {w}_{r} ( {l}_{1 ( i )} , {l}_{2 ( i )} , {l}_{3 ( i )} , {l}_{4 ( i )} ) or {\sum }_{i = 0}^{L - 1} {α}_{i} {w}_{r} ( {l}_{1 ( i )} , {l}_{2 ( i )} )$$

as described herein). In some such examples, UE 115-a may select L codewords denoted as Wₛₑₗ=[w_{r,sel1}, w_{r,sel2}, . . . , w_{r,sel,L}]. For instance, based on the eigenvectors

$${\{ {e}_{l} \}}_{l = 1}^{L}$$

of A or Ã, w_{r,sel,l} may be the codeword in [symbol] ₁ that has the largest correlation coefficient with eₗ. After selecting the L codewords, UE 115-a may determine the combination coefficients α=[α₁, α₂, . . . , α_{L}]^{T}. For instance, UE 115-a may make the determination based on one or more major singular-vectors of AWₛₑₗ. In some examples, UE 115-a may report the indexes of the selected codewords and the quantized amplitudes and phases of α. If \tilde{w}=Wₛₑₗα, then, assuming that the RIS reflection coefficient has a constant module, after network entity 105-a receives the second set of configuration coefficient values 225, network entity 105-a may use \tilde{w}./|\tilde{w}| as a RIS reflection coefficient vector for control transmissions and/or data transmissions (e.g., physical downlink control channel (PDCCH) transmissions and/or physical downlink shared channel (PDSCH) transmissions), where ./ means element-wise division. In some examples, whether UE 115-a reports

$${w}_{r}^{opt}$$

using a Type-1 codebook or a Type-2 codebook may be configured by network entity 105-a, or determined and indicated by UE 115-a.

When multiple paths in H_{gr} and Hᵣᵤ exist, RIS 210 may reflect a signal from multiple incident directions and/or multiple reflective directions, which may increase spatial multiplexing degree and obtain diversity gain. If UE 115-a detects multiple (e.g., denoted Nₚ) propagation paths in a RIS reflective link (e.g., based on channel estimation results), UE 115-a ma y determine to split the RIS surface into multiple sub-surfaces, each of which corresponds to one RIS reflective link propagation path. If there are multiple dominant path powers which are larger than other path powers (e.g., by a threshold amount) based on compressive-sensing based channel estimation results, each of the path power and its associated RIS incident/reflective directions may corresponds to one RIS sub-surface. In some examples, the RIS surface may be evenly split (e.g., the sizes of each subsurface may be identical) or may be unevenly split (e.g., the sizes of each subsurface may be different). Whether the RIS surface is evenly split or unevenly split may be configured by network entity 105-a. For each sub-surface, UE 115-a may determine the RIS reflective coefficient vector

$${\{ {w}_{r , n}^{sub} \}}_{n = 1}^{{N}_{p}}$$

based on the corresponding RIS incident directions, the corresponding RIS reflective directions, the Type-1 codebook, the Type-2 codebook, or any combination thereof. In some examples, UE 115-a may determine the respective coefficient

$${\{ {β}_{n} \}}_{n = 1}^{{N}_{p}}$$

for each sub-surface. Accordingly, UE 115-a may determine an aggregated reflective coefficient vector for the entire RIS in the following form:

$$[ {β}_{1} {w}_{r , 1}^{sub} , {β}_{2} {w}_{r , 2}^{sub} , … , {β}_{n} {w}_{r , n}^{sub} ] .$$

In some examples, UE 115-a may report an indication of whether

$${w}_{r}^{opt}$$

is reported using a Type-1 codebook or a Type-2 codebook; the number of sub-surfaces Nₚ; the RIS surface split result (e.g., whether the RIS surface split is even or uneven); the index of the selected codeword for

$${w}_{r}^{opt}$$

(e.g., if the Type-1 codebook is used); the indices of selected codewords and their combination coefficients for

$${w}_{r}^{opt}$$

(e.g., if the Type-2 codebook is used); the amplitude and phase of per-sub-surface coefficients

$${\{ {β}_{n} \}}_{n = 1}^{{N}_{p}} .$$

In some examples, whether

$${w}_{r}^{opt}$$

is reported using a Type-1 codebook or a Type-2 codebook and/or Nₚ may be reported in a first part of a message (e.g., Part 1 of a CSI report), and the remaining information may be reported in a second part of the message (e.g., Part 2 of a CSI report).

In some examples, UE 115-a may generate a precoding matrix W_{g}. After wᵣ is determined, W_{g} may be determined based on a codebook (e.g., an NR codebook). For instance, an equivalent channel matrix \tilde{H}₁=Hᵣᵤ*Diag(wᵣ)*H_{gr} for a RIS reflective link (e.g., assuming the direct link is blocked) or \tilde{H}₂=H_{gu}+Hᵣᵤ*Diag(wᵣ)*H_{gr} for both a RIS reflective link and a direct link. UE 115-a may report wideband of subbands W_{g} based on \tilde{H}₁ and/or \tilde{H}₂ with a codebook (e.g., an NR codebook). In some examples, wᵣ and W_{g} may be reported together or separately.

In some examples, the techniques described herein may enable UE 115-a to determine RIS coefficients and report the coefficient values to network entity 105-a. In some examples, the techniques described herein may enable UE 115-a to determine a RIS reflection coefficient that is part of an equivalent channel that is then used for performing channel estimation on a composite channel. Additionally, different RIS coefficients may result in different equivalent channels and different equivalent channel gains. In order to increase (e.g., maximize) equivalent channel gain, UE 115-a may determine an updated RIS reflection coefficient (e.g., an optimal RIS reflection coefficient) before performing channel estimation on the composite channel. For instance, UE 115-a may estimate per-link channels (e.g., one for the reflective link and one for the direct link) and may calculate a RIS reflection coefficient. UE 115-a may then use the calculated RIS reflection coefficient to estimate a composite (e.g., equivalent) channel and calculate CSI.

In some examples, the first set of configuration coefficient values 215 may be assistance coefficients used for receiving the one or more reference signals 230 during per-link channel estimation. Using the received reference signals, UE 115-a may determine the second set of configuration coefficient values 225 (e.g., wᵣ) and may transmit the second set of configuration coefficient values 225 to network entity 105-a. In some examples, the codebooks used for reporting wᵣ may be distinct from other codebooks used for transmission and may be associated with higher performance (e.g., due to incorporating signal reflection, incident direction, outgoing direction).

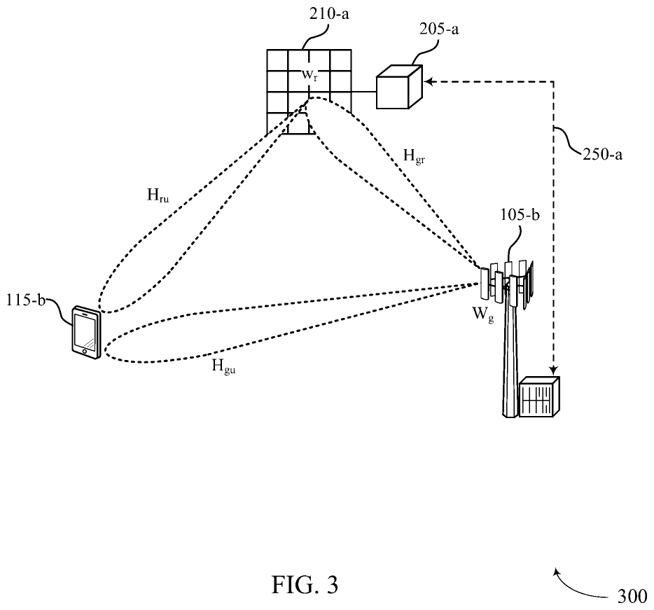

FIG. 3 shows an example of a wireless communications system 300 that supports updating coefficients for a reconfigurable surface in accordance with one or more aspects of the present disclosure. The wireless communications system 300 may implement or be implemented by aspects of the wireless communications systems 100 and/or 200. For example, the wireless communications system 300 may include a network entity 105-b and a UE 115-b, which may be examples of corresponding devices described with reference to FIGS. 1 and/or 2. Similarly, the RIS 210-a, controller 205-a, and interface 250-a may be examples of the corresponding devices and/or elements as described with reference to FIG. 2. In the wireless communications system 300, the UE 115-b may communicate with the network entity 105-b via a RIS 210-a.

As described herein, a reflective link may exist between UE 115-b and network entity 105-b via the RIS 210-a. In some such examples, a direct link (e.g., a direct communication link). between UE 115-b and network entity 105-b may not be established and/or maintained. For instance, the direct link may be blocked by an object (e.g., a building, a tree). In other example, the direct link and the reflective link may be established and/or maintained (e.g., cases in which the direct link is not block by an object). In some examples, network entity 105-b and/or UE 115-b may estimate a channel for a portion of the reflective link between the RIS 210-a and the network entity 105-b as channel estimation coefficient H_{gr}. Additionally, network entity 105-b and/or UE 115-b may estimate a channel for a portion of the reflective link between the RIS 210-a and UE 115-b as channel estimation coefficient Hᵣᵤ. Additionally or alternatively, network entity 105-b and/or UE 115-b may estimate a channel for the direct link between UE 115-b and network entity 105-b as channel estimation coefficient H_{gu}. Additionally, network entity 105-b and/or UE 115-b may generate a reflection coefficient vector wᵣ for the RIS 210-a and may determine a precoding weight matrix W_{g} for network entity 105-b to use in transmitting downlink data transmissions.

In some examples, UE 115-b may receive an indication of a first set of values of the one or more configuration coefficients (e.g., wᵣ) from network entity 105-b (e.g., via the direct link), where the first set of values of the one or more configuration coefficients may be the configured set of values of the one or more configuration coefficients at the RIS 210-a when the indication of the first set of values of the one or more configuration coefficients is transmitted. UE 115-b may use the first set of values of the one or more configuration coefficients and reference signals received from the network entity (e.g., via the reflective link and/or the direct link) to determine a second set of values of the one or more configuration coefficients

$$( e . g . , {w}_{r}^{opt} ) .$$

UE 115-b may transmit an indication of the second set of values of the one or more configuration coefficients to network entity 105-b and/or directly to RIS 210-a. In examples in which UE 115-b transmits the indication of the second set of values to network entity 105-b, the network entity 105-b may transmit another indication of the second set of values to RIS 210-a. After the RIS 210-a receives the second set of values of the configuration coefficient, UE 115-b may perform channel estimation for receiving a control transmission and/or data transmission from the network entity 105-b. During channel estimation, the RIS 210-a may use the second set of values of the one or more configuration coefficients in order to direct reference signals to the UE 115-b.

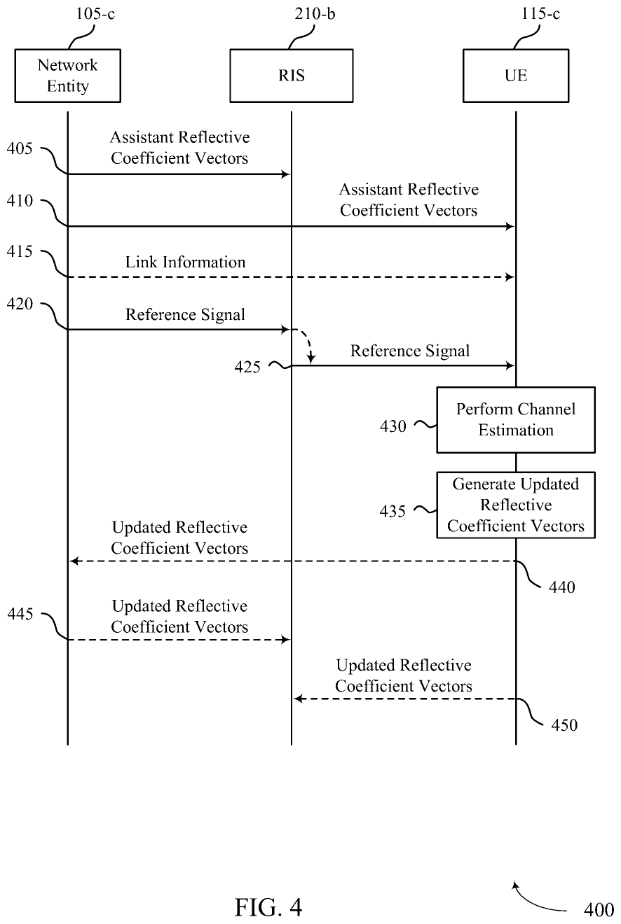

FIG. 4 shows an example of a process flow 400 that supports updating coefficients for a reconfigurable surface in accordance with one or more aspects of the present disclosure. In some examples, process flow 400 may be implemented by one or more aspects of wireless communications systems 100, 200, and/or 300. For instance, UE 115-c may be an example of a UE 115 as described with reference to FIG. 1, UE 115-a as described with reference to FIG. 2, or UE 115-b as described with reference to FIG. 3. Additionally or alternatively, network entity 105-c may be an example of a network entity 105 as described with reference to FIG. 1, network entity 105-a as described with reference to FIG. 2, or network entity 105-b as described with reference to FIG. 3. Additionally or alternatively, RIS 210-b may be an example of a RIS 210 as described with reference to FIG. 2 or RIS 210-a as described with reference to FIG. 3.

At 405, network entity 105-c may transmit, to RIS 210-b, an indication of a first set of one or more values of configuration coefficients (e.g., assistant reflective coefficient vectors).

At 410, network entity 105-c may transmit, to UE 115-c, an indication of the first set of one or more values of configuration coefficients (e.g., assistant reflective coefficient vectors). In some examples, the indication of the first set of one or more values of configuration coefficients includes an indication of a first pattern for activation or deactivation of each of a set of elements of RIS 210-b. In some examples, the indication of the first set of one or more values of configuration coefficients include an indication of a first set of weight vectors. In some examples, the indication of the first set of weight vectors includes an indication of a first set of codeword indices. In some examples, the indication of the first set of weight vectors includes an indication of a respective phase and a respective amplitude for each element of each weight vector of the first set of weight vectors.

At 415, network entity 105-c may transmit, to UE 115-c, an indication of one or more parameters for a communications link between network entity 105-c and RIS 210-b (e.g., a reflective link). In some such examples, the one or more parameters may include a propagation delay, a propagation direction, a transmission power, or any combination thereof.

At 420, network entity 105-c may transmit one or more reference signals (e.g., CSI-RSs) to RIS 210-b while RIS 210-b is configured in accordance with the first set of one or more values of the configuration coefficients. At 425, RIS 210-b may reflect the one or more reference signals to UE 115-c.

At 430, UE 115-c may perform channel estimation as described herein. At 435, UE 115-c may generate a second set of one or more values of the configuration coefficients for RIS 210-b (e.g., updated reflective coefficient vectors). For instance, UE 115-c may determine, based on the first set of one or more values of the configuration coefficients and receiving the one or more reference signals, a second set of one or more values of the configuration coefficients for the reconfigurable surface.

At 440, UE 115-c may transmit, to network entity 105-c, an indication of the second set of one more values of the configuration coefficients for RIS 210-b.

At 445, network entity 105-c may transmit, to RIS 210-b, an indication of the second set of one or more values of the configuration coefficients for RIS 210-b. At 450, UE 115-c may transmit, to RIS 210-b, a second indication of the second set of one or more values of the configuration coefficients for RIS 210-b. In some examples, transmitting the indication of the second set of one or more values of the configuration coefficients is based on receiving the indication of the one or more parameters (e.g., at 415). In some examples, the indication of the second set of one or more values of the configuration coefficients includes an indication of a second pattern for activation or deactivation of each of a set of elements of the reconfigurable surface. In some examples, the indication of a second set of one or more values of configuration coefficients includes an indication of a second set of weight vectors. In some examples, the indication of the second set of weight vectors includes an indication of a second set of codeword indices. In some examples, the indication of the second set of weight vectors includes an indication of a respective phase and respective amplitude for each element of each weight vector of the second set of weight vectors.

In some examples, the indication of the second set of one or more values of the configuration coefficients indicates a codeword from a codebook. In some such examples, UE 115-c may transmit, to network entity 105-c and/or RIS 210-b, an indication of whether the codeword is from a first type of codebook or a second type of codebook. In some examples, the second set of one or more values of the configuration coefficients corresponds to a weighted sum of a set of codewords. In some such examples, the indication of the second set of one or more values of the configuration coefficients indicates the set of codewords and a set of weights for obtaining the weighted sum of the set of codewords. In some examples, the second set of one or more values of the configuration coefficients is provided via a message from UE 115-c. In some such examples, the message includes an indication of a quantity of sub-surfaces included in RIS 210-b. Additionally or alternatively, the message further includes an indication of whether the sub-surfaces included in RIS 210-b are equal or unequal in size.

In some examples, the second set of one or more values of the configuration coefficients for RIS 210-b include a respective set of one or more values of configuration coefficients for each sub-surface of a set of sub-surfaces included in RIS 210-b. In some such examples, the indication of the second set of one or more values of the configuration coefficients may indicate a respective one or more codewords, respective combination coefficients for the one or more codewords, or both, for each sub-surface of the set of sub-surfaces included in the reconfigurable surface. In some examples, the indication of the second set of one or more values of the configuration coefficients indicates a respective phase and a respective amplitude for each value of the second set of one or more values of the configuration coefficients for each sub-surface of the set of sub-surfaces included in the reconfigurable surface.

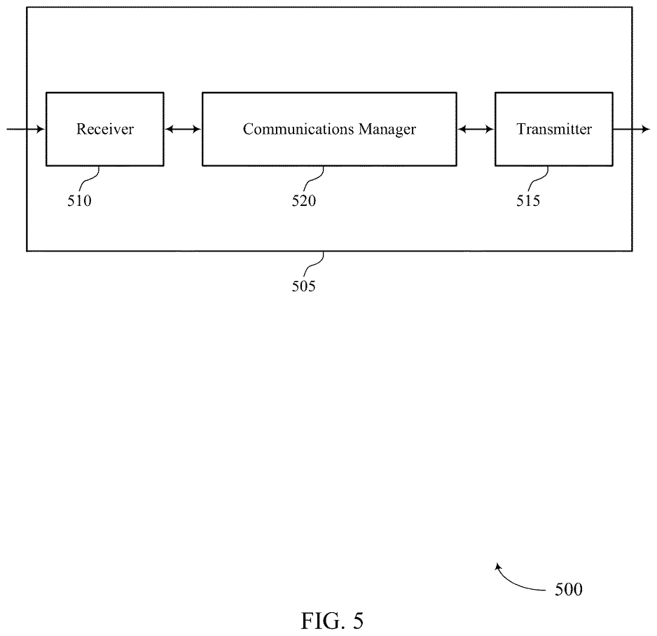

FIG. 5 shows a block diagram 500 of a device 505 that supports updating coefficients for a reconfigurable surface in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to updating coefficients for a reconfigurable surface). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to updating coefficients for a reconfigurable surface). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of updating coefficients for a reconfigurable surface as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

Additionally, or alternatively, the communications manager 520 may support wireless communication at a UE in accordance with examples as disclosed herein. For example, the communications manager 520 may be configured as or otherwise support a means for receiving, from a network entity, an indication of a first set of one or more values of configuration coefficients for a reconfigurable surface. The communications manager 520 may be configured as or otherwise support a means for receiving, from the network entity, one or more reference signals via the reconfigurable surface while the reconfigurable surface is configured in accordance with the first set of one or more values of the configuration coefficients. The communications manager 520 may be configured as or otherwise support a means for determining, based on the first set of one or more values of the configuration coefficients and receiving the one or more reference signals, a second set of one or more values of the configuration coefficients for the reconfigurable surface. The communications manager 520 may be configured as or otherwise support a means for transmitting, to the network entity, an indication of the second set of one or more values of the configuration coefficients for the reconfigurable surface.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for a device 505 to use channel estimation to determine one or more values of one or more configuration coefficients for a reconfigurable surface, which may enable the reconfigurable surface to more accurately reflect signals toward the device 505.

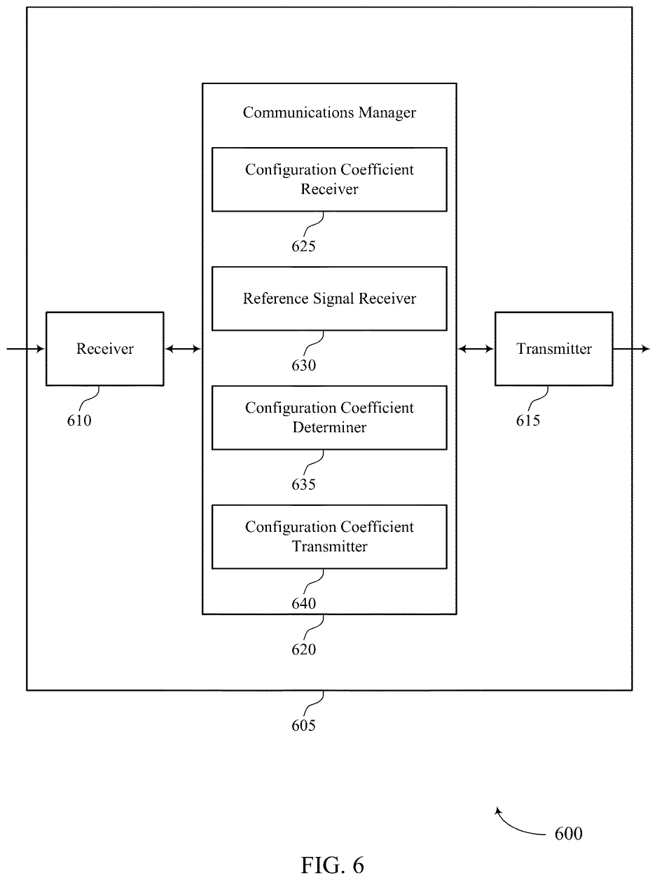

FIG. 6 shows a block diagram 600 of a device 605 that supports updating coefficients for a reconfigurable surface in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to updating coefficients for a reconfigurable surface). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to updating coefficients for a reconfigurable surface). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of updating coefficients for a reconfigurable surface as described herein. For example, the communications manager 620 may include a configuration coefficient receiver 625, a reference signal receiver 630, a configuration coefficient determiner 635, a configuration coefficient transmitter 640, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. The configuration coefficient receiver 625 may be configured as or otherwise support a means for receiving, from a network entity, an indication of a first set of one or more values of configuration coefficients for a reconfigurable surface. The reference signal receiver 630 may be configured as or otherwise support a means for receiving, from the network entity, one or more reference signals via the reconfigurable surface while the reconfigurable surface is configured in accordance with the first set of one or more values of the configuration coefficients. The configuration coefficient determiner 635 may be configured as or otherwise support a means for determining, based on the first set of one or more values of the configuration coefficients and receiving the one or more reference signals, a second set of one or more values of the configuration coefficients for the reconfigurable surface. The configuration coefficient transmitter 640 may be configured as or otherwise support a means for transmitting, to the network entity, an indication of the second set of one or more values of the configuration coefficients for the reconfigurable surface.

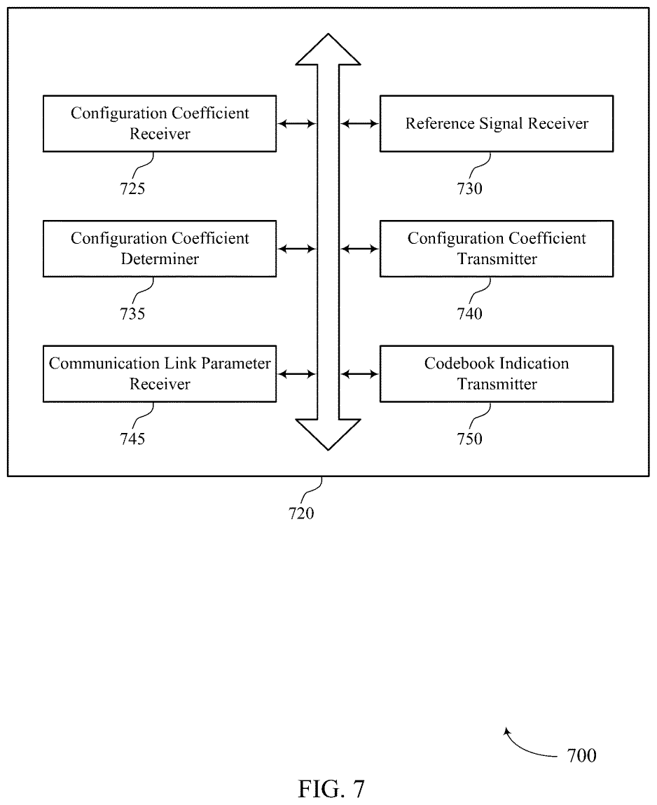

FIG. 7 shows a block diagram 700 of a communications manager 720 that supports updating coefficients for a reconfigurable surface in accordance with one or more aspects of the present disclosure. The communications manager 720 may be an example of aspects of a communications manager 520, a communications manager 620, or both, as described herein. The communications manager 720, or various components thereof, may be an example of means for performing various aspects of updating coefficients for a reconfigurable surface as described herein. For example, the communications manager 720 may include a configuration coefficient receiver 725, a reference signal receiver 730, a configuration coefficient determiner 735, a configuration coefficient transmitter 740, a communication link parameter receiver 745, a codebook indication transmitter 750, or any combination thereof. Each of these components may communicate, directly or indirectly, with one another (e.g., via one or more buses).

Additionally, or alternatively, the communications manager 720 may support wireless communication at a UE in accordance with examples as disclosed herein. The configuration coefficient receiver 725 may be configured as or otherwise support a means for receiving, from a network entity, an indication of a first set of one or more values of configuration coefficients for a reconfigurable surface. The reference signal receiver 730 may be configured as or otherwise support a means for receiving, from the network entity, one or more reference signals via the reconfigurable surface while the reconfigurable surface is configured in accordance with the first set of one or more values of the configuration coefficients. The configuration coefficient determiner 735 may be configured as or otherwise support a means for determining, based on the first set of one or more values of the configuration coefficients and receiving the one or more reference signals, a second set of one or more values of the configuration coefficients for the reconfigurable surface. The configuration coefficient transmitter 740 may be configured as or otherwise support a means for transmitting, to the network entity, an indication of the second set of one or more values of the configuration coefficients for the reconfigurable surface.

In some examples, the communication link parameter receiver 745 may be configured as or otherwise support a means for receiving, from the network entity, an indication of one or more parameters for a communications link between the network entity and the reconfigurable surface, where the one or more parameters include a propagation delay, a propagation direction, a channel gain, or any combination thereof, and where transmitting the indication of the second set of one or more values of the configuration coefficients is based on receiving the indication of the one or more parameters.

In some examples, the indication of the first set of one or more values of configuration coefficients includes an indication of a first pattern for activation or deactivation of each of a set of elements of the reconfigurable surface. In some examples, the indication of the second set of one or more values of the configuration coefficients includes an indication of a second pattern for activation or deactivation of each of the set of elements of the reconfigurable surface or an indication of a set of weight vectors.

In some examples, the indication of the first set of one or more values of configuration coefficients includes an indication of a first set of weight vectors. In some examples, the indication of a second set of one or more values of configuration coefficients includes an indication of a second set of weight vectors or an indication of a pattern for activation or deactivation of each of a set of elements of the reconfigurable surface.

In some examples, the indication of the first set of weight vectors includes an indication of a first set of codewords indices or includes an indication of a respective phase and a respective amplitude for each element of each weight vector of the first set of weight vectors. In some examples, the indication of the second set of weight vectors includes an indication of a second set of codeword indices or includes an indication of a respective phase and a respective amplitude for each element of each weight vector of the second set of weight vectors.

In some examples, the indication of the second set of one or more values of the configuration coefficients indicates a codeword from a codebook.

In some examples, the codebook indication transmitter 750 may be configured as or otherwise support a means for transmitting, to the network entity, an indication of whether the codeword is from a first type of codebook or a second type of codebook.

In some examples, the second set of one or more values of the configuration coefficients corresponds to a weighted sum of a set of multiple codewords. In some examples, the indication of the second set of one or more values of the configuration coefficients indicates the set of multiple codewords and a set of weights for obtaining the weighted sum of the set of multiple codewords.

In some examples, the configuration coefficient transmitter 740 may be configured as or otherwise support a means for transmitting, to the network entity, an indication of a quantity of sub-surfaces included in the reconfigurable surface.

In some examples, the configuration coefficient transmitter 740 may be configured as or otherwise support a means for transmitting, to the network entity, an indication of whether the sub-surfaces included in the reconfigurable surface are equal or unequal in size.

In some examples, the second set of one or more values of the configuration coefficients for the reconfigurable surface includes a respective set of one or more values of configuration coefficients for each sub-surface of a set of multiple sub-surfaces included in the reconfigurable surface.

In some examples, the indication of the second set of one or more values of the configuration coefficients indicates a respective one or more codewords, respective combination coefficients for the one or more codewords, or both, for each sub-surface of the set of multiple sub-surfaces included in the reconfigurable surface.

In some examples, the indication of the second set of one or more values of the configuration coefficients indicates a respective phase and a respective amplitude for each value of the second set of one or more values of the configuration coefficients for each sub-surface of the set of multiple sub-surfaces included in the reconfigurable surface.

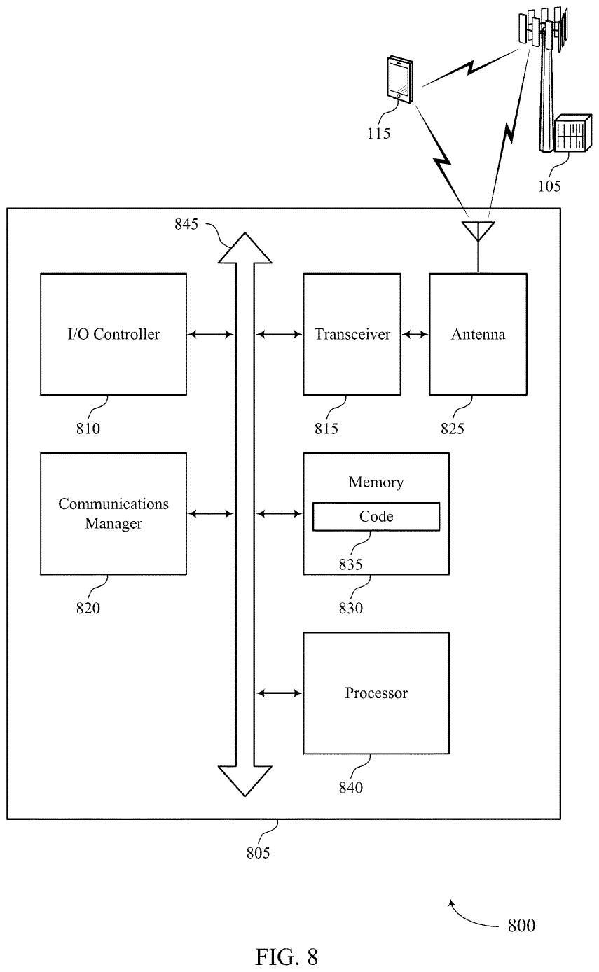

FIG. 8 shows a diagram of a system 800 including a device 805 that supports updating coefficients for a reconfigurable surface in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting updating coefficients for a reconfigurable surface). For example, the device 805 or a component of the device 805 may include a processor 840 and memory 830 coupled with or to the processor 840, the processor 840 and memory 830 configured to perform various functions described herein.

Additionally, or alternatively, the communications manager 820 may support wireless communication at a UE in accordance with examples as disclosed herein. For example, the communications manager 820 may be configured as or otherwise support a means for receiving, from a network entity, an indication of a first set of one or more values of configuration coefficients for a reconfigurable surface. The communications manager 820 may be configured as or otherwise support a means for receiving, from the network entity, one or more reference signals via the reconfigurable surface while the reconfigurable surface is configured in accordance with the first set of one or more values of the configuration coefficients. The communications manager 820 may be configured as or otherwise support a means for determining, based on the first set of one or more values of the configuration coefficients and receiving the one or more reference signals, a second set of one or more values of the configuration coefficients for the reconfigurable surface. The communications manager 820 may be configured as or otherwise support a means for transmitting, to the network entity, an indication of the second set of one or more values of the configuration coefficients for the reconfigurable surface.

By including or configuring the communications manager 820 in accordance with examples as described herein, the device 805 may support techniques for a device 805 to use channel estimation to determine one or more values for one or more configuration coefficients for a reconfigurable surface, which may enable the reconfigurable surface to more accurately reflect signals toward the device 805.

In some examples, the communications manager 820 may be configured to perform various operations (e.g., receiving, monitoring, transmitting) using or otherwise in cooperation with the transceiver 815, the one or more antennas 825, or any combination thereof. For instance, the communications manager 820 may be configured to receive or transmit messages or other signaling as described herein via transceiver 815. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of updating coefficients for a reconfigurable surface as described herein, or the processor 840 and the memory 830 may be otherwise configured to perform or support such operations.

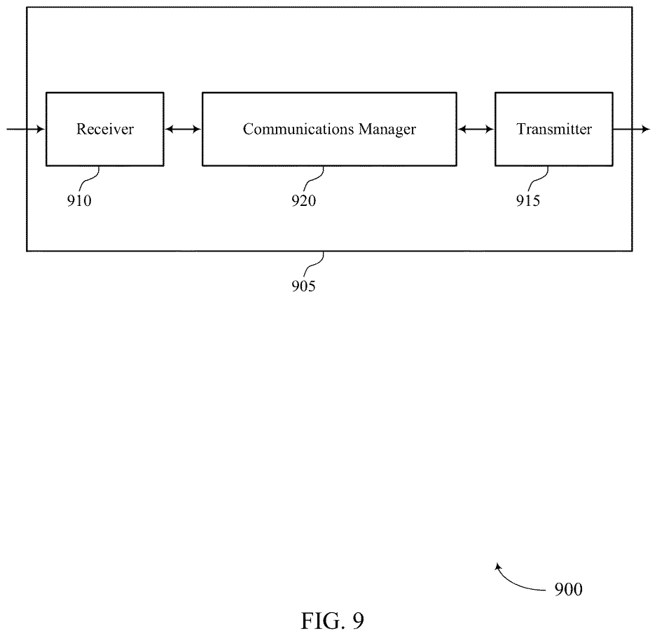

FIG. 9 shows a block diagram 900 of a device 905 that supports updating coefficients for a reconfigurable surface in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of updating coefficients for a reconfigurable surface as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

Additionally, or alternatively, the communications manager 920 may support wireless communication at a network entity in accordance with examples as disclosed herein. For example, the communications manager 920 may be configured as or otherwise support a means for outputting an indication of a first set of one or more values of configuration coefficients for a reconfigurable surface. The communications manager 920 may be configured as or otherwise support a means for outputting one or more reference signals via the reconfigurable surface while the reconfigurable surface is configured in accordance with the first set of one or more values of the configuration coefficients. The communications manager 920 may be configured as or otherwise support a means for obtaining an indication of a second set of one or more values of the configuration coefficients for the reconfigurable surface based on outputting the indication of the first set of one or more values of the configuration coefficients and outputting the one or more reference signals.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for a device 905 to enable a UE to use channel estimation to determine one or more values for one or more configuration coefficients for a reconfigurable surface, which may enable the reconfigurable surface to more accurately reflect signals toward the UE from the device 905.

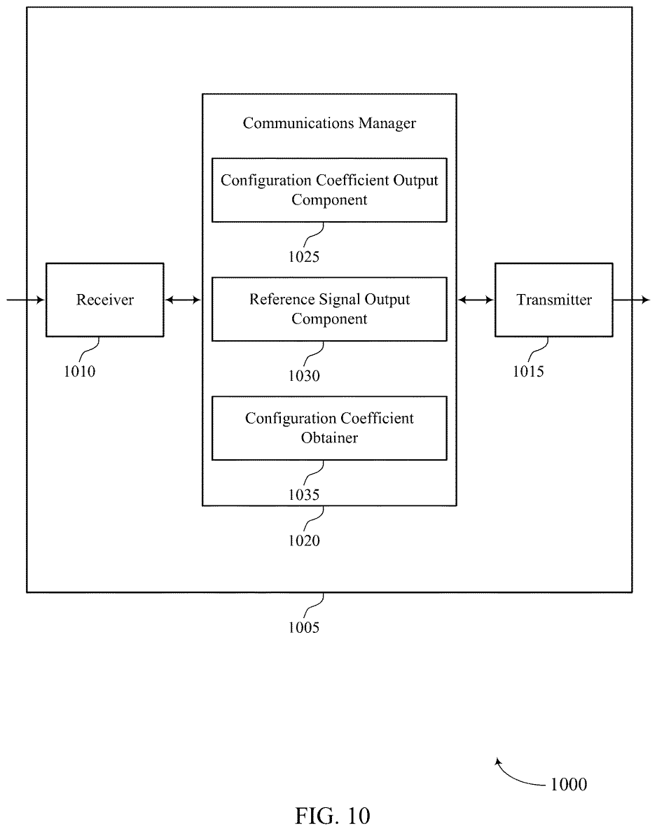

FIG. 10 shows a block diagram 1000 of a device 1005 that supports updating coefficients for a reconfigurable surface in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of updating coefficients for a reconfigurable surface as described herein. For example, the communications manager 1020 may include a configuration coefficient output component 1025, a reference signal output component 1030, a configuration coefficient obtainer 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity in accordance with examples as disclosed herein. The configuration coefficient output component 1025 may be configured as or otherwise support a means for outputting an indication of a first set of one or more values of configuration coefficients for a reconfigurable surface. The reference signal output component 1030 may be configured as or otherwise support a means for outputting one or more reference signals via the reconfigurable surface while the reconfigurable surface is configured in accordance with the first set of one or more values of the configuration coefficients. The configuration coefficient obtainer 1035 may be configured as or otherwise support a means for obtaining an indication of a second set of one or more values of the configuration coefficients for the reconfigurable surface based on outputting the indication of the first set of one or more values of the configuration coefficients and outputting the one or more reference signals.

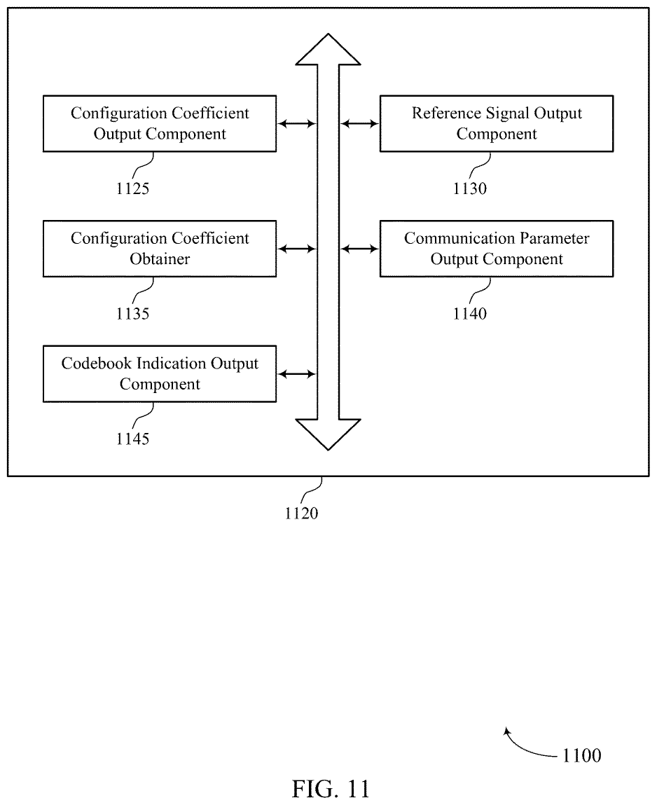

FIG. 11 shows a block diagram 1100 of a communications manager 1120 that supports updating coefficients for a reconfigurable surface in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of updating coefficients for a reconfigurable surface as described herein. For example, the communications manager 1120 may include a configuration coefficient output component 1125, a reference signal output component 1130, a configuration coefficient obtainer 1135, a communication parameter output component 1140, a codebook indication output component 1145, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

Additionally, or alternatively, the communications manager 1120 may support wireless communication at a network entity in accordance with examples as disclosed herein. The configuration coefficient output component 1125 may be configured as or otherwise support a means for outputting an indication of a first set of one or more values of configuration coefficients for a reconfigurable surface. The reference signal output component 1130 may be configured as or otherwise support a means for outputting one or more reference signals via the reconfigurable surface while the reconfigurable surface is configured in accordance with the first set of one or more values of the configuration coefficients. The configuration coefficient obtainer 1135 may be configured as or otherwise support a means for obtaining an indication of a second set of one or more values of the configuration coefficients for the reconfigurable surface based on outputting the indication of the first set of one or more values of the configuration coefficients and outputting the one or more reference signals.

In some examples, the communication parameter output component 1140 may be configured as or otherwise support a means for outputting an indication of one or more parameters for a communications link between the network entity and the reconfigurable surface, where the one or more parameters include a propagation delay, a propagation direction, a transmission power, or any combination thereof, and where obtaining the indication of the second set of one or more values of the configuration coefficients is based on outputting the indication of the one or more parameters.

In some examples, the indication of the first set of one or more values of configuration coefficients includes an indication of a first pattern for activation or deactivation of each of a set of elements of the reconfigurable surface. In some examples, the indication of the second set of one or more values of the configuration coefficients includes an indication of a second pattern for activation or deactivation of each of the set of elements of the reconfigurable surface or an indication of a set of weight vectors.

In some examples, the indication of the first set of one or more values of configuration coefficients includes an indication of a first set of weight vectors. In some examples, the indication of a second set of one or more values of configuration coefficients includes an indication of a second set of weight vectors or an indication of a pattern for activation or deactivation of each of a set of elements of the reconfigurable surface.

In some examples, the indication of the first set of weight vectors includes an indication of a first set of codewords indices or comprises an indication of a respective phase and a respective amplitude for each element of each weight vector of the first set of weight vectors. In some examples, the indication of the second set of weight vectors includes an indication of a second set of codeword indices or comprises an indication of a respective phase and a respective amplitude for each element of each weight vector of the second set of weight vectors.

In some examples, the indication of the second set of one or more values of the configuration coefficients indicates a codeword from a codebook.

In some examples, the codebook indication output component 1145 may be configured as or otherwise support a means for obtaining an indication of whether the codeword is from a first type of codebook or a second type of codebook.

In some examples, the second set of one or more values of the configuration coefficients corresponds to a weighted sum of a set of multiple codewords. In some examples, the indication of the second set of one or more values of the configuration coefficients indicates the set of multiple codewords and a set of weights for obtaining the weighted sum of the set of multiple codewords.

In some examples, the configuration coefficient obtainer 1135 may be configured as or otherwise support a means for obtaining an indication of a quantity of sub-surfaces included in the reconfigurable surface.

In some examples, the configuration coefficient obtainer 1135 may be configured as or otherwise support a means for obtaining an indication of whether the sub-surfaces included in the reconfigurable surface are equal or unequal in size.

In some examples, the second set of one or more values of the configuration coefficients for the reconfigurable surface includes a respective set of one or more values of configuration coefficients for each sub-surface of a set of multiple sub-surfaces included in the reconfigurable surface.

In some examples, the indication of the second set of one or more values of the configuration coefficients indicates a respective one or more codewords, respective combination coefficients for the one or more codewords, or both, for each sub-surface of the set of multiple sub-surfaces included in the reconfigurable surface.

In some examples, the indication of the second set of one or more values of the configuration coefficients indicates a respective phase and a respective amplitude for each value of the second set of one or more values of the configuration coefficients for each sub-surface of the set of multiple sub-surfaces included in the reconfigurable surface.

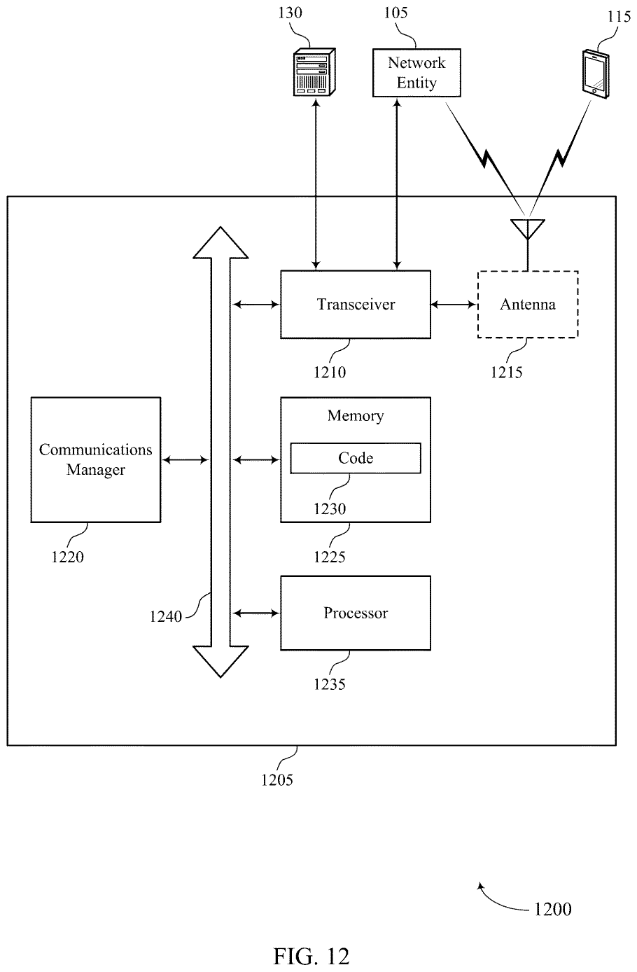

FIG. 12 shows a diagram of a system 1200 including a device 1205 that supports updating coefficients for a reconfigurable surface in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting updating coefficients for a reconfigurable surface). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

Additionally, or alternatively, the communications manager 1220 may support wireless communication at a network entity in accordance with examples as disclosed herein. For example, the communications manager 1220 may be configured as or otherwise support a means for outputting an indication of a first set of one or more values of configuration coefficients for a reconfigurable surface. The communications manager 1220 may be configured as or otherwise support a means for outputting one or more reference signals via the reconfigurable surface while the reconfigurable surface is configured in accordance with the first set of one or more values of the configuration coefficients. The communications manager 1220 may be configured as or otherwise support a means for obtaining an indication of a second set of one or more values of the configuration coefficients for the reconfigurable surface based on outputting the indication of the first set of one or more values of the configuration coefficients and outputting the one or more reference signals.

By including or configuring the communications manager 1220 in accordance with examples as described herein, the device 1205 may support techniques for a device 1205 to enable a UE to use channel estimation to determine one or more values of one or more configuration coefficients for a reconfigurable surface, which may enable the reconfigurable surface to more accurately reflect signals toward the UE from the device 1205.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. For instance, the communications manager 1220 may be configured to receive or transmit messages or other signaling as described herein via transceiver 1210. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of updating coefficients for a reconfigurable surface as described herein, or the processor 1235 and the memory 1225 may be otherwise configured to perform or support such operations.

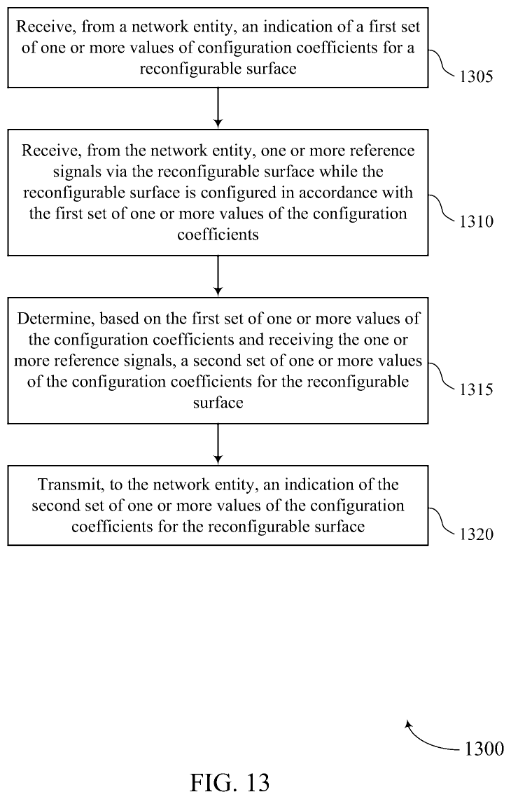

FIG. 13 shows a flowchart illustrating a method 1300 that supports updating coefficients for a reconfigurable surface in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving, from a network entity, an indication of a first set of one or more values of configuration coefficients for a reconfigurable surface. The operations of 1305 may be performed in accordance with examples as disclosed herein. In some examples, aspects of the operations of 1305 may be performed by a configuration coefficient receiver 725 as described with reference to FIG. 7. Additionally or alternatively, means for performing 1305 may, but not necessarily, include, for example, I/O controller 810, transceiver 815, communications manager 820, antenna 825, memory 830, code 835, processor 840, or any combination thereof.

At 1310, the method may include receiving, from the network entity, one or more reference signals via the reconfigurable surface while the reconfigurable surface is configured in accordance with the first set of one or more values of the configuration coefficients. The operations of 1310 may be performed in accordance with examples as disclosed herein. In some examples, aspects of the operations of 1310 may be performed by a reference signal receiver 730 as described with reference to FIG. 7. Additionally or alternatively, means for performing 1310 may, but not necessarily, include, for example, I/O controller 810, transceiver 815, communications manager 820, antenna 825, memory 830, code 835, processor 840, or any combination thereof

At 1315, the method may include determining, based on the first set of one or more values of the configuration coefficients and receiving the one or more reference signals, a second set of one or more values of the configuration coefficients for the reconfigurable surface. The operations of 1315 may be performed in accordance with examples as disclosed herein. In some examples, aspects of the operations of 1315 may be performed by a configuration coefficient determiner 735 as described with reference to FIG. 7. Additionally or alternatively, means for performing 1315 may, but not necessarily, include, for example, I/O controller 810, transceiver 815, communications manager 820, antenna 825, memory 830, code 835, processor 840, or any combination thereof

At 1320, the method may include transmitting, to the network entity, an indication of the second set of one or more values of the configuration coefficients for the reconfigurable surface. The operations of 1320 may be performed in accordance with examples as disclosed herein. In some examples, aspects of the operations of 1320 may be performed by a configuration coefficient transmitter 740 as described with reference to FIG. 7. Additionally or alternatively, means for performing 1320 may, but not necessarily, include, for example, I/O controller 810, transceiver 815, communications manager 820, antenna 825, memory 830, code 835, processor 840, or any combination thereof

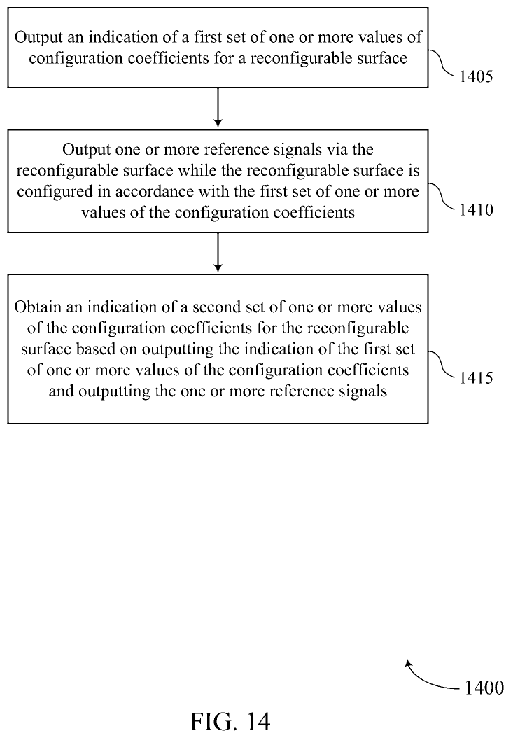

FIG. 14 shows a flowchart illustrating a method 1400 that supports updating coefficients for a reconfigurable surface in accordance with one or more aspects of the present disclosure. The operations of the method 1400 may be implemented by a network entity or its components as described herein. For example, the operations of the method 1400 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1405, the method may include outputting an indication of a first set of one or more values of configuration coefficients for a reconfigurable surface. The operations of 1405 may be performed in accordance with examples as disclosed herein. In some examples, aspects of the operations of 1405 may be performed by a configuration coefficient output component 1125 as described with reference to FIG. 11. Additionally or alternatively, means for performing 1405 may, but not necessarily, include, for example, transceiver 1210, antenna 1215, communications manager 1220, memory 1225, code 1230, processor 1235, or any combination thereof.

At 1410, the method may include outputting one or more reference signals via the reconfigurable surface while the reconfigurable surface is configured in accordance with the first set of one or more values of the configuration coefficients. The operations of 1410 may be performed in accordance with examples as disclosed herein. In some examples, aspects of the operations of 1410 may be performed by a reference signal output component 1130 as described with reference to FIG. 11. Additionally or alternatively, means for performing 1410 may, but not necessarily, include, for example, transceiver 1210, antenna 1215, communications manager 1220, memory 1225, code 1230, processor 1235, or any combination thereof

At 1415, the method may include obtaining an indication of a second set of one or more values of the configuration coefficients for the reconfigurable surface based on outputting the indication of the first set of one or more values of the configuration coefficients and outputting the one or more reference signals. The operations of 1415 may be performed in accordance with examples as disclosed herein. In some examples, aspects of the operations of 1415 may be performed by a configuration coefficient obtainer 1135 as described with reference to FIG. 11. Additionally or alternatively, means for performing 1415 may, but not necessarily, include, for example, transceiver 1210, antenna 1215, communications manager 1220, memory 1225, code 1230, processor 1235, or any combination thereof.

The following provides an overview of aspects of the present disclosure:

Aspect 1: A method for wireless communication at a UE, comprising: receiving, from a network entity, an indication of a first set of one or more values of configuration coefficients for a reconfigurable surface; receiving, from the network entity, one or more reference signals via the reconfigurable surface while the reconfigurable surface is configured in accordance with the first set of one or more values of the configuration coefficients; determining, based at least in part on the first set of one or more values of the configuration coefficients and receiving the one or more reference signals, a second set of one or more values of the configuration coefficients for the reconfigurable surface; and transmitting, to the network entity, an indication of the second set of one or more values of the configuration coefficients for the reconfigurable surface.

Aspect 2: The method of aspect 1, further comprising: receiving, from the network entity, an indication of one or more parameters for a communications link between the network entity and the reconfigurable surface, wherein the one or more parameters comprise a propagation delay, a propagation direction, a transmission power, or any combination thereof, and wherein transmitting the indication of the second set of one or more values of the configuration coefficients is based at least in part on receiving the indication of the one or more parameters.

Aspect 3: The method of any of aspects 1 through 2, wherein the indication of the first set of one or more values of configuration coefficients comprises an indication of a first pattern for activation or deactivation of each of a set of elements of the reconfigurable surface, and the indication of the second set of one or more values of the configuration coefficients comprises an indication of a second pattern for activation or deactivation of each of the set of elements of the reconfigurable surface.

Aspect 4: The method of any of aspects 1 through 3, wherein the indication of the first set of one or more values of configuration coefficients comprises an indication of a first set of weight vectors, and the indication of a second set of one or more values of configuration coefficients comprises an indication of a second set of weight vectors.

Aspect 5: The method of aspect 4, wherein the indication of the first set of weight vectors comprises an indication of a first set of codewords indices, and the indication of the second set of weight vectors comprises an indication of a second set of codeword indices.

Aspect 6: The method of any of aspects 4 through 5, wherein the indication of the first set of weight vectors comprises an indication of a respective phase and a respective amplitude for each element of each weight vector of the first set of weight vectors, and the indication of the second set of weight vectors comprises an indication of a respective phase and a respective amplitude for each element of each weight vector of the second set of weight vectors.

Aspect 7: The method of any of aspects 1 through 6, wherein the indication of the second set of one or more values of the configuration coefficients indicates a codeword from a codebook.

Aspect 8: The method of aspect 7, further comprising: transmitting, to the network entity, an indication of whether the codeword is from a first type of codebook or a second type of codebook.

Aspect 9: The method of any of aspects 1 through 8, wherein the second set of one or more values of the configuration coefficients corresponds to a weighted sum of a plurality of codewords, and the indication of the second set of one or more values of the configuration coefficients indicates the plurality of codewords and a set of weights for obtaining the weighted sum of the plurality of codewords.

Aspect 10: The method of any of aspects 1 through 9, wherein the second set of one or more values of the configuration coefficients is provided via a message from the UE, and the message comprises an indication of a quantity of sub-surfaces included in the reconfigurable surface.

Aspect 11: The method of aspect 10, wherein the message further comprises an indication of whether the sub-surfaces included in the reconfigurable surface are equal or unequal in size.

Aspect 12: The method of any of aspects 1 through 11, wherein the second set of one or more values of the configuration coefficients for the reconfigurable surface comprises a respective set of one or more values of configuration coefficients for each sub-surface of a plurality of sub-surfaces included in the reconfigurable surface.

Aspect 13: The method of aspect 12, wherein the indication of the second set of one or more values of the configuration coefficients indicates a respective one or more codebooks, respective combination coefficients for the one or more codebooks, or both, for each sub-surface of the plurality of sub-surfaces included in the reconfigurable surface.

Aspect 14: The method of any of aspects 12 through 13, wherein the indication of the second set of one or more values of the configuration coefficients indicates a respective phase and a respective amplitude for each value of the second set of one or more values of the configuration coefficients for each sub-surface of the plurality of sub-surfaces included in the reconfigurable surface.

Aspect 15: A method for wireless communication at a network entity, comprising: outputting an indication of a first set of one or more values of configuration coefficients for a reconfigurable surface; outputting one or more reference signals via the reconfigurable surface while the reconfigurable surface is configured in accordance with the first set of one or more values of the configuration coefficients; and obtaining an indication of a second set of one or more values of the configuration coefficients for the reconfigurable surface based at least in part on transmitting the indication of the first set of one or more values of the configuration coefficients and transmitting the one or more reference signals.

Aspect 16: The method of aspect 15, further comprising: outputting an indication of one or more parameters for a communications link between the network entity and the reconfigurable surface, wherein the one or more parameters comprise a propagation delay, a propagation direction, a transmission power, or any combination thereof, and wherein receiving the indication of the second set of one or more values of the configuration coefficients is based at least in part on transmitting the indication of the one or more parameters.

Aspect 17: The method of any of aspects 15 through 16, wherein the indication of the first set of one or more values of configuration coefficients comprises an indication of a first pattern for activation or deactivation of each of a set of elements of the reconfigurable surface, and the indication of the second set of one or more values of the configuration coefficients comprises an indication of a second pattern for activation or deactivation of each of the set of elements of the reconfigurable surface.

Aspect 18: The method of any of aspects 15 through 17, wherein the indication of the first set of one or more values of configuration coefficients comprises an indication of a first set of weight vectors, and the indication of a second set of one or more values of configuration coefficients comprises an indication of a second set of weight vectors.

Aspect 19: The method of aspect 18, wherein the indication of the first set of weight vectors comprises an indication of a first set of codewords indices, and the indication of the second set of weight vectors comprises an indication of a second set of codeword indices.

Aspect 20: The method of any of aspects 18 through 19, wherein the indication of the first set of weight vectors comprises an indication of a respective phase and a respective amplitude for each element of each weight vector of the first set of weight vectors, and the indication of the second set of weight vectors comprises an indication of a respective phase and a respective amplitude for each element of each weight vector of the second set of weight vectors.

Aspect 21: The method of any of aspects 15 through 20, wherein the indication of the second set of one or more values of the configuration coefficients indicates a codeword from a codebook.

Aspect 22: The method of aspect 21, further comprising: outputting an indication of whether the codeword is from a first type of codebook or a second type of codebook.

Aspect 23: The method of any of aspects 15 through 22, wherein the second set of one or more values of the configuration coefficients corresponds to a weighted sum of a plurality of codewords, and the indication of the second set of one or more values of the configuration coefficients indicates the plurality of codewords and a set of weights for obtaining the weighted sum of the plurality of codewords.

Aspect 24: The method of any of aspects 15 through 23, wherein the second set of one or more values of the configuration coefficients is provided via a message, and the message comprises an indication of a quantity of sub-surfaces included in the reconfigurable surface.

Aspect 25: The method of aspect 24, wherein the message further comprises an indication of whether the sub-surfaces included in the reconfigurable surface are equal or unequal in size.

Aspect 26: The method of any of aspects 15 through 25, wherein the second set of one or more values of the configuration coefficients for the reconfigurable surface comprises a respective set of one or more values of configuration coefficients for each sub-surface of a plurality of sub-surfaces included in the reconfigurable surface.

Aspect 27: The method of aspect 26, wherein the indication of the second set of one or more values of the configuration coefficients indicates a respective one or more codebooks, respective combination coefficients for the one or more codebooks, or both, for each sub-surface of the plurality of sub-surfaces included in the reconfigurable surface.

Aspect 28: The method of any of aspects 26 through 27, wherein the indication of the second set of one or more values of the configuration coefficients indicates a respective phase and a respective amplitude for each value of the second set of one or more values of the configuration coefficients for each sub-surface of the plurality of sub-surfaces included in the reconfigurable surface.

Aspect 29: An apparatus comprising a memory, transceiver, and at least one processor coupled with the memory and the transceiver, the at least one processor configured to perform a method of any of aspects 1 through 14.

Aspect 30: An apparatus for wireless communication at a UE, comprising at least one means for performing a method of any of aspects 1 through 14.

Aspect 31: A non-transitory computer-readable medium storing code for wireless communication at a UE, the code comprising instructions executable by a processor to perform a method of any of aspects 1 through 14.

Aspect 32: An apparatus comprising a memory and at least one processor coupled with the memory, the at least one processor configured to perform a method of any of aspects 15 through 28.

Aspect 33: An apparatus for wireless communication at a network entity, comprising at least one means for performing a method of any of aspects 15 through 28.

Aspect 34: A non-transitory computer-readable medium storing code for wireless communication at a network entity, the code comprising instructions executable by a processor to perform a method of any of aspects 15 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database, or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication, comprising:
memory;
a transceiver; and
at least one processor of a user equipment (UE), the at least one processor coupled with the memory and the transceiver and configured to cause the apparatus to:
receive, from a network entity via the transceiver, an indication of a first set of one or more values of configuration coefficients for a reconfigurable surface;
receive, from the network entity via the transceiver, one or more reference signals via the reconfigurable surface while the reconfigurable surface is configured in accordance with the first set of one or more values of the configuration coefficients;
determine, based at least in part on the first set of one or more values of the configuration coefficients and receiving the one or more reference signals, a second set of one or more values of the configuration coefficients for the reconfigurable surface; and
transmit, to the network entity via the transceiver, an indication of the second set of one or more values of the configuration coefficients for the reconfigurable surface.

2. The apparatus of claim 1, the at least one processor further configured to cause the apparatus to:
receive, from the network entity via the transceiver, an indication of one or more parameters for a communications link between the network entity and the reconfigurable surface, wherein the one or more parameters comprise a propagation delay, a propagation direction, a channel gain, or any combination thereof, and wherein the at least one processor is configured to transmit the indication of the second set of one or more values of the configuration coefficients based at least in part on receiving the indication of the one or more parameters.

3. The apparatus of claim 1, wherein:
the indication of the first set of one or more values of configuration coefficients comprises an indication of a first pattern for activation or deactivation of each of a set of elements of the reconfigurable surface, and
the indication of the second set of one or more values of the configuration coefficients comprises an indication of a second pattern for activation or deactivation of each of the set of elements of the reconfigurable surface or an indication of a set of weight vectors.

4. The apparatus of claim 1, wherein:
the indication of the first set of one or more values of configuration coefficients comprises an indication of a first set of weight vectors, and
the indication of a second set of one or more values of configuration coefficients comprises an indication of a second set of weight vectors or an indication of a pattern for activation or deactivation of each of a set of elements of the reconfigurable surface.

5. The apparatus of claim 4, wherein:
the indication of the first set of weight vectors comprises an indication of a first set of codeword indices or comprises an indication of a respective phase and a respective amplitude for each element of each weight vector of the first set of weight vectors, and
the indication of the second set of weight vectors comprises an indication of a second set of codeword indices or comprises an indication of a respective phase and a respective amplitude for each element of each weight vector of the second set of weight vectors.

6. The apparatus of claim 1, wherein the indication of the second set of one or more values of the configuration coefficients indicates a codeword from a codebook.

7. The apparatus of claim 6, the at least one processor further configured to cause the apparatus to:
transmit, to the network entity via the transceiver, an indication of whether the codeword is from a first type of codebook or a second type of codebook.

8. The apparatus of claim 1, wherein:
the second set of one or more values of the configuration coefficients corresponds to a weighted sum of a plurality of codewords, and
the indication of the second set of one or more values of the configuration coefficients indicates the plurality of codewords and a set of weights for obtaining the weighted sum of the plurality of codewords.

9. The apparatus of claim 1, the at least one processor further configured to cause the apparatus to:
transmit, to the network entity via the transceiver, an indication of a quantity of sub-surfaces included in the reconfigurable surface.

10. The apparatus of claim 9, the at least one processor further configured to cause the apparatus to:
transmit, to the network entity via the transceiver, an indication of whether the sub-surfaces included in the reconfigurable surface are equal or unequal in size.

11. The apparatus of claim 1, wherein the second set of one or more values of the configuration coefficients for the reconfigurable surface comprises a respective set of one or more values of configuration coefficients for each sub-surface of a plurality of sub-surfaces included in the reconfigurable surface.

12. The apparatus of claim 11, wherein the indication of the second set of one or more values of the configuration coefficients indicates a respective one or more codewords, respective combination coefficients for the one or more codewords, or both, for each sub-surface of the plurality of sub-surfaces included in the reconfigurable surface.

13. The apparatus of claim 11, wherein the indication of the second set of one or more values of the configuration coefficients indicates a respective phase and a respective amplitude for each value of the second set of one or more values of the configuration coefficients for each sub-surface of the plurality of sub-surfaces included in the reconfigurable surface.

14.-26. (canceled)

27. A method for wireless communication at a user equipment (UE), comprising:
receiving, from a network entity, an indication of a first set of one or more values of configuration coefficients for a reconfigurable surface;
receiving, from the network entity, one or more reference signals via the reconfigurable surface while the reconfigurable surface is configured in accordance with the first set of one or more values of the configuration coefficients;
determining, based at least in part on the first set of one or more values of the configuration coefficients and receiving the one or more reference signals, a second set of one or more values of the configuration coefficients for the reconfigurable surface; and
transmitting, to the network entity, an indication of the second set of one or more values of the configuration coefficients for the reconfigurable surface.

28. The method of claim 27, further comprising:
receiving, from the network entity, an indication of one or more parameters for a communications link between the network entity and the reconfigurable surface, wherein the one or more parameters comprise a propagation delay, a propagation direction, a channel gain, or any combination thereof, and wherein transmitting the indication of the second set of one or more values of the configuration coefficients is based at least in part on receiving the indication of the one or more parameters.

29. The method of claim 27, wherein the indication of the second set of one or more values of the configuration coefficients indicates a codeword from a codebook.

30. A method for wireless communication at a network entity, comprising:
outputting an indication of a first set of one or more values of configuration coefficients for a reconfigurable surface;
outputting one or more reference signals via the reconfigurable surface while the reconfigurable surface is configured in accordance with the first set of one or more values of the configuration coefficients; and
obtaining an indication of a second set of one or more values of the configuration coefficients for the reconfigurable surface based at least in part on outputting the indication of the first set of one or more values of the configuration coefficients and outputting the one or more reference signals.
